(19) United States
(12) Patent Application Publication
(10) Pub. No.: US 2026/0259639 A1
(43) Pub. Date: Sep. 3, 2026

(54) MENU DISPLAY METHOD AND INTELLIGENT DISPLAY APPARATUS

(71) Applicant: BOE TECHNOLOGY GROUP CO., LTD., Beijing (CN)

(72) Inventors: Lifei ZHAO, Beijing (CN); Tieli CHEN, Beijing (CN)

(21) Appl. No.: 18/993,558

(22) PCT Filed: Oct. 14, 2022
(86) PCT No.: PCT/CN2022/125481

§ 371 Date: Jan. 12, 2025

(51) Int. Cl. G06F 3/0482

(52) U.S. Cl. CPC G06F 3/0482

(57) ABSTRACT

A menu display method and an intelligent display apparatus are provided for solving a problem that the menu interaction mode is complicated in various application scenes in the intelligent display apparatus with a large-sized screen, and thus, providing a more portable and concise menu interaction mode for a user and improving interaction experiences of the user. The method includes: displaying an application menu corresponding to an application scene in response to a menu triggering operation triggered by a user in the application scene, the application menu being configured to display a plurality of menu items, the menu triggering operation is the same for different application scenes, and at least part of the menu items are displayed to be different for different application scenes.

### TECHNICAL FIELD

The present disclosure relates to the field of human-computer interaction technology, in particular to a menu display method and an intelligent display apparatus.

### BACKGROUND

With the popularization of intelligent apparatuses, an intelligent display apparatus with a large-sized screen and various functions gradually enters people's lives. The intelligent display apparatus is mainly used in the fields of education and office and the like, and a touch display screen of the intelligent display apparatus may be touched by using a hand or a stylus to realize the human-computer interaction.

At present, the intelligent display apparatus with the large-sized screen is installed thereon with various applications, including writing applications such as an electronic whiteboard or the like, common office software, a video conference and the like, which can provide multiple application scenes for users. However, in a case where the intelligent display apparatus provides the multiple application scenes, a menu interaction mode thereof is relatively complicated. Therefore, it is a technical problem to be solved urgently to provide a concise and portable menu interaction mode for the users.

### SUMMARY

A menu display method and an intelligent display apparatus are provided for solving a problem that an intelligent display apparatus with a large-sized screen has a complicated menu interaction mode in multiple application scenes, so that a more portable and concise menu interaction mode is provided for users, and the interaction experience of the users is improved.

In a first aspect, an embodiment of the present disclosure provides a menu display method, including: displaying an application menu corresponding to an application scene in response to a menu triggering operation triggered by a user in the application scene; the application menu is configured to display a plurality of menu items, the menu triggering operation is the same for different application scenes, and at least one of the menu items is displayed to be different for different application scenes.

In some implementations, the menu items include at least one first menu item and at least one second menu item; the first menu item is displayed by the application menu to be the same for different application scenes, and the second menu item is displayed by the application menu to be different for different application scenes.

In some implementations, the at least one first menu item is configured to display a system menu item or an application menu item; the at least one second menu item is configured to display an application menu item or a function menu item; and the system menu item is configured to trigger a function built in an operating system to be executed, the application menu item is configured to trigger to enter a corresponding third-party application interface, and the function menu item is configured to trigger a corresponding function in the application scene to be executed.

In some implementations, the at least one first menu item is configured to display the system menu item or the application menu item, and the at least one second menu item is configured to display the function menu item; or the at least one first menu item is configured to display the system menu item and the at least one second menu item is configured to display the application menu item.

In some implementations, the application scene is a Home application, the at least one first menu item is configured to display the system menu item, and the at least one second menu item is configured to display the application menu item.

In some implementations, a third-party application corresponding to the application menu item displayed is started up in response to a start triggering operation of the user on the application menu item in the Home application.

In some implementations, the application scene is a non-Home application, the at least one first menu item is configured to display the system menu item or the application menu item, and the at least one second menu item is configured to display the function menu item.

In some implementations, the application menu includes a first menu and a second menu, and the menu triggering operation includes a first triggering operation and a second triggering operation; the first menu is displayed in response to the first triggering operation triggered by the user in the application scene; the second menu is displayed in response to the second triggering operation triggered by the user in the first menu; the first triggering operation is the same for different application scenes, and the second triggering operation is the same for different application scenes.

In some implementations, the first menu is configured to display the first menu item to be the same for different application scenes, and the second menu is configured to display the second menu item to be different for different application scenes; or the first menu is configured to display the second menu item to be different for different application scenes, and the second menu is configured to display the first menu item to be the same for different application scenes.

In some implementations, the application menu is a sidebar menu, and the first menu and the second menu are arranged left and right or up and down.

In some implementations, the application menu is a tool palette menu, the first menu is a first annular region, the second menu is a second annular region, and the first annular region is distributed around the second annular region or the second annular region is distributed around the first annular region.

In some implementations, the application menu is a tool palette menu, the tool palette menu includes a third annular region and a fourth annular region, the third annular region is distributed around the fourth annular region or the fourth annular region is distributed around the third annular region; the third annular region is configured to display the first menu item to be the same for different application scenes, and the fourth annular region is configured to display the second menu item to be different for different application scenes; or the third annular region is configured to display the second menu item to be different for different application scenes, and the fourth annular region is configured to display the first menu item to be the same for different application scenes.

In some implementations, the displaying an application menu corresponding to an application scene in response to a menu triggering operation triggered by a user in the application scene includes: in response to the application scene being a first application scene, the application menu includes a third menu; in response to the application scene being a second application scene, the application menu includes a fourth menu; and at least one menu item displayed by the third menu is different from any menu item displayed by the fourth menu, and the menu triggering operation triggered in the first application scene is the same as the menu triggering operation triggered in the second application scene.

In some implementations, a fifth menu is displayed in response to a triggering operation on the fourth menu by the user, and at least one menu item displayed by the fifth menu is the same as at least one menu item displayed by the third menu.

In some implementations, the tool palette menu further includes a central region in a center of the first annular region, and the central region is configured to trigger an operation corresponding to the menu item to be executed.

In some implementations, the central region is configured to display an edit menu item, and trigger the menu item in the tool palette menu and/or the application scene to be edited; or the central region is configured to display a menu sub-item of the menu item in the tool palette menu and trigger a function of the menu sub-item to be executed.

In some implementations, the displaying an application menu corresponding to an application scene in response to a menu triggering operation triggered by a user in the application scene includes: displaying a suspended menu control; and displaying the application menu corresponding to the application scene in response to a triggering operation of the user on the suspended menu control.

In some implementations, the application menu is a tool palette menu, and the tool palette menu includes a central region and at least one annular region surrounding the central region; and the displaying the application menu corresponding to the application scene in response to a triggering operation of the user on the suspended menu control includes: sequentially displaying the central region and the at least one annular region of the tool palette menu from inside to outside or from outside to inside in response to a first triggering operation of the user on the suspended menu control; or displaying the central region of the tool palette menu in response to a second triggering operation of the user on the suspended menu control, and sequentially displaying the at least one annular region of the tool palette menu from inside to outside or from outside to inside in response to a third triggering operation of the user on the central region.

In some implementations, the at least one annular region of the tool palette menu includes a plurality of block sub-regions displaying menu items in one-to-one correspondence; and the block sub-regions of the at least one annular region are sequentially displayed in a clockwise direction or a counterclockwise direction during the at least one annular region being displayed.

In a second aspect, an embodiment of the present disclosure provides an intelligent display apparatus, including a display screen and a controller, the display screen is configured to display a content; and the controller is configured to display an application menu corresponding to an application scene in response to a menu triggering operation triggered by a user in the application scene, the application menu is configured to display a plurality of menu items, the menu triggering operation is the same for different application scenes, and at least one of the menu item is displayed to be different for different application scenes.

In some implementations, the menu items include at least one first menu item and at least one second menu item, the first menu item is displayed by the application menu to be the same for different application scenes, and the second menu item is displayed by the application menu to be different for different application scenes.

In some implementations, the first menu item is configured to display a system menu item or an application menu item, the second menu item is configured to display an application menu item or a function menu item, the system menu item is configured to trigger a function built in an operating system to be executed, the application menu item is configured to trigger to enter a corresponding third-party application interface, and the function menu item is configured to trigger a corresponding function in the application scene to be executed.

In some implementations, the first menu item is configured to display the system menu item or the application menu item, and the second menu item is configured to display the function menu item; or the first menu item is configured to display the system menu item, and the second menu item is configured to display the application menu item.

In some implementations, the application scene is a Home application, the first menu item is configured to display the system menu item, and the second menu item is configured to display the application menu item.

In some implementations, the controller is configured to start up a third-party application corresponding to the application menu item in response to a start triggering operation of the user on the application menu item displayed in the Home application.

In some implementations, the application scene is a non-Home application, the first menu item is configured to display the system menu item or the application menu item, and the second menu item is configured to display the function menu item.

In some implementations, the application menu includes a first menu and a second menu, and the menu triggering operation includes a first triggering operation and a second triggering operation; the controller is configured to: display the first menu in response to the first triggering operation triggered by the user in the application scene; and display the second menu in response to the second triggering operation triggered by the user in the first menu, the first triggering operation is the same for different application scenes, and the second triggering operation is the same for different application scenes.

In some implementations, the first menu is configured to display the first menu item to be the same for different application scenes, and the second menu is configured to display the second menu item to be different for different application scenes; or the first menu is configured to display the second menu item to be different for different application scenes, and the second menu is configured to display the first menu item to be the same for different application scenes.

In some implementations, the application menu is a sidebar menu, and the first menu and the second menu are arranged left and right or up and down.

In some implementations, the application menu is a tool palette menu, the first menu is a first annular region, and the second menu is a second annular region, and the first annular region is distributed around the second annular region, or the second annular region is distributed around the first annular region.

In some implementations, the application menu is a tool palette menu, the tool palette menu includes a third annular region and a fourth annular region, the third annular region is distributed around the fourth annular region or the fourth annular region is distributed around the third annular region; the third annular region is configured to display the first menu item to be the same for different application scenes, and the fourth annular region is configured to display the second menu item to be different for different application scenes; or the third annular region is configured to display the second menu item to be different for different application scenes, and the fourth annular region is configured to display the first menu item to be the same for different application scenes.

In some implementations, the controller is configured to enable the application menu includes a third menu in response to the application scene being a first application scene, and the application menu includes a fourth menu in response to the application scene being a second application scene, at least one menu item displayed by the third menu is different from any menu item displayed by the fourth menu, and the menu triggering operation triggered in the first application scene is the same as the menu triggering operation triggered in the second application scene.

In some implementations, the controller is configured to display a fifth menu in response to a triggering operation on the fourth menu by the user, at least one menu item displayed by the fifth menu is the same at least one menu item displayed by the third menu.

In some implementations, the tool palette menu further includes a central region located in a center of the first annular region, and the central region is configured to trigger an operation corresponding to the menu item to be executed.

In some implementations, the central region is configured to display an edit menu item, and trigger the menu item in the tool palette menu and/or the application scene to be edited; or the central region is configured to display a menu sub-item of the menu item in the tool palette menu and trigger a function of the menu sub-item to be executed.

In some implementations, the controller is configured to: display a suspended menu control; display the application menu corresponding to the application scene in response to a triggering operation of the user on the suspended menu control.

In some implementations, the application menu is a tool palette menu, and the tool palette menu includes a central region and at least one annular region surrounding the central region; the controller is configured to: sequentially display the central region and the at least one annular region of the tool palette menu from inside to outside or from outside to inside in response to a first triggering operation of the user on the suspended menu control; or display the central region of the tool palette menu in response to a second triggering operation of the user on the suspended menu control, and sequentially display the at least one annular region of the tool palette menu from inside to outside or from outside to inside in response to a third triggering operation of the user on the central region.

In some implementations, the at least one annular region of the tool palette menu includes a plurality of block sub-regions displaying menu items in one-to-one correspondence; the block sub-regions of the at least one annular region are sequentially displayed in a clockwise direction or a counterclockwise direction during the at least one annular region being displayed.

In a third aspect, an embodiment of the present disclosure further provides a menu display apparatus including a display unit configured to display an application menu corresponding to an application scene in response to a menu triggering operation triggered by a user in the application scene, the application menu is configured to display a plurality of menu items, the menu triggering operation is the same for different application scenes, and at least one of the menu items is displayed to be different for different application scenes.

In some implementations, the menu items include at least one first menu item and at least one second menu item, the first menu item is displayed by the application menu to be the same for different application scenes, and the second menu item is displayed by the application menu to be different for different application scenes.

In some implementations, the at least one first menu item is configured to display a system menu item or an application menu item, the at least one second menu item is configured to display an application menu item or a function menu item, the system menu item is configured to trigger a function built in an operating system to be executed, the application menu item is configured to trigger to enter a corresponding third-party application interface, and the function menu item is configured to trigger a corresponding function in the application scene to be executed.

In some implementations, the first menu item is configured to display the system menu item or the application menu item, and the second menu item is configured to display the function menu item; or the first menu item is configured to display the system menu item and the second menu item is configured to display the application menu item.

In some implementations, when the application scene is a Home application, the first menu item is configured to display the system menu item, and the second menu item is configured to display the application menu item.

In some implementations, the display unit is configured to start the third-party application corresponding to the application menu item in response to a user's start triggering operation on the application menu item in the Home application.

In some implementations, the application scene is a non-Home application, the first menu item is configured to display the system menu item or the application menu item, and the second menu item is configured to display the function menu item.

In some implementations, the application menu includes a first menu and a second menu, and the menu triggering operation includes a first triggering operation and a second triggering operation; the display unit is configured to display the first menu in response to the first triggering operation triggered by the user in the application scene; display the second menu in response to the second triggering operation triggered by the user in the first menu; the first triggering operation is the same for different application scenes, and the second triggering operation is the same for different application scenes.

In some implementations, the first menu is configured to display the first menu item to be the same for different application scenes, and the second menu is configured to display the second menu item to be different for different application scenes; or the first menu is configured to display the second menu item to be different for in different application scenes, and the second menu is configured to display the first menu item to be the same for different application scenes.

In some implementations, the application menu is a sidebar menu, and the first menu and the second menu are arranged left and right or up and down.

In some implementations, the application menu is a tool palette menu, the first menu is a first annular region, the second menu is a second annular region, and the first annular region is distributed around the second annular region or the second annular region is distributed around the first annular region.

In some implementations, the application menu is a tool palette menu, the tool palette menu includes a third annular region and a fourth annular region, the third annular region is distributed around the fourth annular region or the fourth annular region is distributed around the third annular region; the third annular region is configured to display the first menu item to be the same for different application scenes, and the fourth annular region is configured to display the second menu item to be different for different application scenes; or the third annular region is configured to display the second menu item to be different for different application scenes, and the fourth annular region is configured to display the first menu item to be the same for different application scenes.

In some implementations, the application menu includes a third menu in response to the application scene being a first application scene, and the application menu includes a fourth menu in response to the application scene being a second application scene, at least one menu item displayed by the third menu is different from any menu item displayed by the fourth menu, and the menu triggering operation triggered in the first application scene is the same as the menu triggering operation triggered in the second application scene.

In some implementations, the display unit is configured to display a fifth menu in response to a triggering operation on the fourth menu by the user, at least one menu item displayed by the fifth menu is the same as at least one menu item displayed by the third menu.

In some implementations, the tool palette menu further includes a central region located in a center of the first annular region, and the central region is configured to trigger an operation corresponding to the menu item to be executed.

In some implementations, the central region is configured to display an edit menu item, and trigger the menu item in the tool palette menu and/or the application scene to be edited; or the central region is configured to display a menu sub-item of the menu item in the tool palette menu and trigger a function of the menu sub-item to be executed.

In some implementations, the display unit is configured to display a suspended menu control, and display an application menu corresponding to the application scene in response to a triggering operation of the user on the suspended menu control.

In some implementations, the application menu is a tool palette menu, and the tool palette menu includes a central region and at least one annular region surrounding the central region, the display unit is configured to display the central region and the at least one annular region of the tool palette menu sequentially from inside to outside or from outside to inside in response to a first triggering operation of the user on the suspended menu control; or display the central region of the tool palette menu in response to a second triggering operation of the user on the suspended menu control, and display the at least one annular region of the tool palette menu sequentially from inside to outside or from outside to inside in response to a third triggering operation of the user on the central region.

In some implementations, the at least one annular region of the tool palette menu includes a plurality of block sub-regions displaying the menu items in one-to-one correspondence, the block sub-regions of the at least one annular region are sequentially displayed in a clockwise direction or a counterclockwise direction during the at least one annular region being displayed.

In a fourth aspect, an embodiment of the present disclosure further provides a menu display method of an electronic interactive display panel, the electronic interactive display panel includes a touch display screen, and the menu display method includes: displaying a tool palette menu of an application on the touch display screen, the tool palette menu including a plurality of first-level menu options in one-to-one correspondence with one or more tools, the tool palette menu having a regular shape including a central region and at least one annular region surrounding the central region, and the at least one annular region including a plurality of block sub-regions displaying the plurality of first-level menu options in one-to-one correspondence.

In some implementations, the tool palette menu further includes an adjustment control for displaying the first-level menu options, and the adjustment control is arranged at least in the central region.

In some implementations, an outermost annular region of the at least one annular region is a first annular region, the first-level menu options are displayed in the first annular region, and the adjustment control arranged in the central region includes lower-level menu options of the first-level menu options; in response to the user calling out the tool palette menu of the application on the touch display screen, the first-level menu options are displayed in the first annular region, a function of a selected one of the first-level menu options is started, and the lower-level menu option of the started first-level menu option is displayed in the central region; or the lower-level menu option of the selected first-level menu option is displayed in the central region in response to a selection operation of the user on the first-level menu option.

In some implementations, at least one of the tools includes one or more attributes; the lower-level menu option of the first-level menu option corresponding to the tool is configured to display the one or more attributes; in response to the lower-level menu option being configured to display more than one attributes, the method further including: switching the attribute currently displayed to be another attribute to be displayed in response to an operation of the user on the attribute of the lower-level menu option currently displayed.

In some implementations, the tool palette menu is a writing configuration menu, and the first-level menu options include one or more of an option of handwriting tool, an option of stylus tool, an option of eraser tool, an option of file insertion tool, an option of canvas dragging tool, a cancel function option, or a restore function option; the attribute of the stylus tool includes at least one of a width, a transparency or a color of a track, the attribute of the handwriting tool includes at least one of a width, a transparency or a color of a track, and the attribute of the eraser tool includes at least one of an erasing area of the eraser tool or an erasing shape of the eraser tool.

In some implementations, the application of the electronic interactive display panel further includes a partition operation mode, and the method further includes: determining a partition to be controlled by a suspended button or the writing configuration menu according to a triggered position of the suspended button or the writing configuration menu.

In some implementations, in the partition operation mode, one writing configuration menu and at least two partitions are displayed on the touch display screen, different partitions are configured to be written under the same or different writing parameters, and the writing configuration menu is configured to adjust the writing parameter.

In some implementations, the first-level menu options further include an option of the partition operation mode, lower-level menu options of the partition operation mode include a two-partition mode, a three-partition mode, a four-partition mode and a manual partition mode, the method further includes switching between different partition modes in response to continuous selection operations of the user on the lower-level menu options of the partition operation mode.

In some implementations, the application of the electronic interactive display panel further includes a multi-person writing mode, at least two writing configuration menus are displayed on the touch display screen in the multi-person writing mode, the method further includes: determining the writing configuration menu for controlling the writing parameter of a writing operation according to a distance between a writing point of the writing operation and each of the at least two writing configuration menus.

In some implementations, the first-level menu options further include an option for the multi-person writing mode, a lower-level menu option of the multi-person writing mode includes a total number of the writing configuration menus.

In some implementations, regions controlled by the writing configuration menus are determined according to a horizontal distance between any two writing configuration menus, different writing configuration menus are configured with the same or different writing parameters; each writing configuration menu independently controls the writing parameter of the region corresponding to the writing configuration menu.

In a fifth aspect, an embodiment of the present disclosure further provides a computer storage medium having a computer program stored thereon, the computer program, executed by a processor, causes the processor to implement the method in the first aspect.

These and other aspects of the present disclosure will be more readily apparent in the following description of the embodiments.

### BRIEF DESCRIPTION OF DRAWINGS

In order to more clearly illustrate technical solutions according to embodiments of the present disclosure, the drawings accompanying the description of the embodiments will be briefly described below. It is apparent that the drawings accompanying the description below only illustrate some implementations of the present disclosure, and it is obvious for an ordinary skilled person in the art that other drawings may be obtained according to the provided drawings without any creative effort.

FIG. 1 is a flowchart of a menu display method according to an embodiment of the present disclosure.

FIG. 2 is a schematic diagram of a default sidebar of an existing intelligent display apparatus according to an embodiment of the present disclosure.

FIG. 3 is a schematic diagram of a sidebar displayed in a writing software scene according to an embodiment of the present disclosure.

FIG. 4 is a schematic diagram of a sidebar displayed in a video conference software scene according to an embodiment of the present disclosure.

FIG. 5 is a schematic diagram of a sidebar displayed in a video conference software scene according to an embodiment of the present disclosure.

FIGS. 6A to 6B are schematic diagrams of a tool palette menu according to an embodiment of the present disclosure.

FIG. 7 is a schematic diagram illustrating a comparison of tool palette menus according to an embodiment of the present disclosure.

FIG. 8 is a schematic diagram of a tool palette menu according to an embodiment of the present disclosure.

FIGS. 9A to 9B are schematic diagrams of a tool palette menu according to an embodiment of the present disclosure.

FIGS. 10A to 10C are schematic diagrams of tool palette menus displaying different menu items in different scenes according to an embodiment of the present disclosure.

FIG. 11A is a schematic diagram of an editing interface of a menu item according to an embodiment of the present disclosure.

FIG. 11B is a schematic diagram of an editing interface of an application scene according to an embodiment of the present disclosure.

FIG. 12 is a schematic diagram illustrating a function of a user-defined action option according to an embodiment of the present disclosure.

FIG. 13 is a schematic diagram of creating a new action according to an embodiment of the present disclosure.

FIG. 14 is a schematic diagram of a tool palette menu displayed within writing software according to an embodiment of the present disclosure.

FIG. 15 is a schematic diagram of a tool palette menu displayed in an operating system scene according to an embodiment of the present disclosure.

FIG. 16 is a schematic diagram of a tool palette menu displayed within writing software according to an embodiment of the present disclosure.

FIG. 17 is a schematic diagram of an intelligent display apparatus according to an embodiment of the present disclosure.

FIG. 18 is a schematic diagram of a menu display apparatus according to an embodiment of the present disclosure.

FIG. 19 is a flowchart of a menu display method according to an embodiment of the present disclosure.

FIG. 20 is a schematic diagram of a tool palette menu in an electronic interactive display panel according to an embodiment of the present disclosure.

FIG. 21 is a schematic diagram of a tool palette menu in an electronic interactive display panel according to an embodiment of the present disclosure.

FIG. 22 is a schematic diagram illustrating a positional relationship between an region where a user is writing and a full display screen of an electronic interactive display panel according to an embodiment of the present disclosure.

FIG. 23 is a schematic diagram illustrating a position of a suspended button during being triggered and a partition controlled by the suspended button in an electronic interactive display panel according to an embodiment of the present disclosure.

FIG. 24 is a schematic diagram illustrating a distance relationship between positions at which different users perform writing operations on a touch display screen and suspended buttons in an electronic interactive display panel according to an embodiment of the present disclosure.

FIG. 25 is a schematic diagram of positions at which different users perform writing operations on a touch display screen and corresponding suspended buttons in an electronic interactive display panel according to an embodiment of the present disclosure.

### DETAIL DESCRIPTION OF EMBODIMENTS

In order to make the objects, technical solutions and advantages of the present disclosure more apparent, the present disclosure will be described in further detail with reference to the accompanying drawings. It is apparent that the described embodiments are only some implementations of the present disclosure, not all embodiments. All other embodiments, which can be derived by an ordinary skilled person in the art from the embodiments disclosed herein without any creative effort, shall fall within the protection scope of the present disclosure.

The term “and/or” in the embodiments of the present disclosure describes an association relationship of associated objects, and indicates that three relationships may exist. For example, A and/or B may indicate: A exists alone, A and B exist simultaneously, and B exists alone. The character “/” generally indicates that the associated objects before “/” and after “/” are in an “or” relationship.

The application scene described in any embodiment of the present disclosure is for more clearly illustrating the technical solution of the embodiment of the present disclosure, and does not form a limitation on the technical solution in the embodiment of the present disclosure. As known by an ordinary skilled person in the art, with the occurrence of a new application scene, the technical solution in the embodiment of the present disclosure is applicable to similar technical problems. In the description of the present disclosure, “a plurality” means two or more, unless otherwise specified.

With the popularization of intelligent apparatuses, an intelligent display apparatus with a large-sized screen and various functions gradually enters people's lives. The intelligent display apparatus is mainly used in the fields of education and office and the like, and a touch display screen of the intelligent display apparatus may be touched by using a hand and a stylus to realize the human-computer interaction. At present, the intelligent display apparatus with the large-sized screen is installed with various applications thereon, including writing applications such as an electronic whiteboard or the like, common office software, a video conference and the like, which can provide multiple application scenes for users. However, during the intelligent display apparatus providing multiple application scenes, a menu interaction mode is complicated. For example, the current intelligent display apparatus provides various tools and applications for users, and is usually provided with a sidebar, including common menu items such as information source switching, setting, network setting, annotation, spotlight, screen capture, timer, voter, and the like, but these tools are not all desired in each scene during the intelligent display apparatus being operated for the user. For example, during an electronic whiteboard application being operated, the function of annotation is not desired. Moreover, the intelligent display apparatus has many functions hidden in more applications or a program. For example, the intelligent display apparatus has an intelligent calculation function in the electronic whiteboard application, but the intelligent calculation function is hidden in writing software, if the user wants to use the intelligent calculation function, the user is desired to find and click the writing software in a desktop to enter the intelligent calculation function, which is complicated. Therefore, it is a technical problem to be solved urgently to provide a concise and portable menu interaction mode for the user.

In view of above, an embodiment of the present disclosure provides a menu display method, in which a menu is associated with an application scene, the menu is displayed based on the application scene, different application scenes correspond to different function menu items, a tool most suitable for each current application scene is provided, so that a user can quickly reach corresponding functions in different application scenes, can find the desired function in a shorter time without switching to search more applications, can call an application or a gadget desired in the current scene in a shorter time, and can call the function hidden in the application, therefore, the operation is more convenient and faster, current expectations of the user are intuitively met, and the use experience of the user is effectively improved.

It should be noted that the intelligent display apparatus in the embodiment of the present disclosure refers to a large-sized (generally, greater than 50 inches) intelligent interactive display apparatus with a touch handwriting function, the intelligent display apparatus is installed with a writing program such as an electronic whiteboard, the user may write on the display apparatus by using a finger, an active stylus or a passive stylus or the like, and the intelligent display apparatus may include a display module such as a liquid crystal display (LCD), an organic electroluminescence display, and electronic ink, so that the handwriting may be displayed in real time.

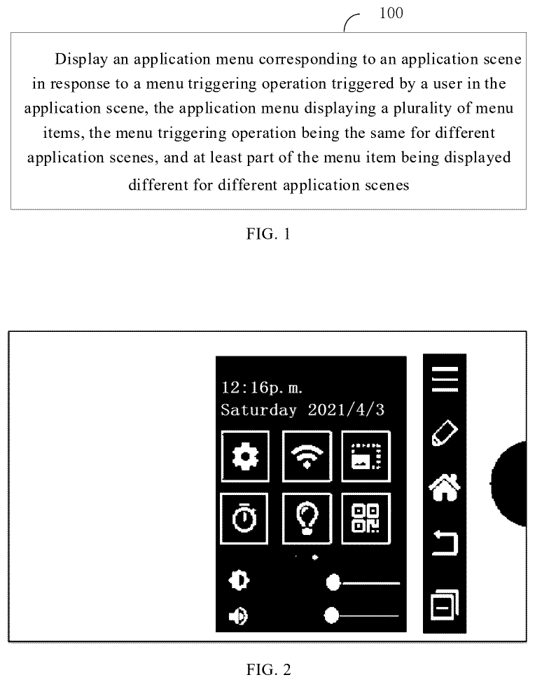

As shown in FIG. 1, a specific implementation flow of the menu display method provided in the embodiment of the present disclosure includes a step 100.

At step 100, displaying an application menu corresponding to an application scene in response to a menu triggering operation triggered by a user in the application scene.

It should be noted that the application scene in the embodiment of the present disclosure refers to a scene in a current operating system in which an application is displayed on a current display interface. The application scene includes, but is not limited to, a scene in which the user operates and uses the application or the application software displayed on the current interface. The application scene in the embodiment of the present disclosure includes: a Home application and a non-Home application. The Home application may provide a startup interface, and displays a home page or a system homepage of the operating system on the display interface, and the non-Home application includes, but is not limited to, a third-party application. The third-party application may be a self-designed application or an existing application, which is not limited in the embodiment of the present disclosure.

The application menu is configured to display a plurality of menu items, the menu triggering operation is the same for different application scenes, and at least part of the menu items are displayed to be different for different application scenes.

Different application scenes may be understood as that different applications or application software is used. The menu triggering operation is the same in different applications, but at least part of the menu items in the application menus are displayed to be different in different applications, the menu items to be displayed are changed based on the application scene, so that the user can more conveniently find the menu items commonly used in the current application scene, and can more quickly find desired tools (the menu items) in different application scenes, thereby the operation of the user is more quick and convenient, and the interaction experience is improved.

In some implementations, the application menus may be displayed to be different in different application scenes after the user uses the same menu triggering operation in different application scenes. For example, after the user uses a single-finger long-press operation in a system homepage scene, the application menu is displayed to include a plurality of menu items related to the system, and after the user uses the single-finger long-press operation in a writing program, the application menu is displayed to include a plurality of menu items related to writing. Although the same menu triggering operation is used, different menu items in the application menus are triggered to be displayed in different application scenes, but a style of the application menus is the same in different application scenes.

The menu items in the application menu may be displayed in the form of icons and/or characters, which is not limited in the embodiment of the present disclosure.

In some implementations, the menu triggering operation in the embodiment of the present disclosure includes, but is not limited to, one of a long-press operation, a sliding operation, a click operation, and a double-click operation, which is not limited in the embodiment of the present disclosure.

In some implementations, the application menu displayed in the embodiment of the present disclosure may be displayed in a suspended manner. The term “suspended” means that elements in upper and lower layers have specific motion rules, respectively, and the element in the upper layer may be referred to as “suspended” element, such as a navigation bar or a tab bar or the like, which is suspended with respect to a content region. It should be understood that the application menu in the embodiment of the present disclosure may be suspended over the display interface of the intelligent display apparatus.

In some implementations, the menu items in the embodiment of the present disclosure include at least one first menu item and at least one second menu item, the first menu item is displayed by the application menu to be the same for different application scenes, and the second menu item is displayed by the application menu to be different for different application scenes.

In some implementations, the at least one first menu item is configured to display a system menu item or an application menu item, the at least one second menu item is configured to display an application menu item or a function menu item, the system menu item is configured to trigger a function built in the system to be executed, the application menu item is configured to trigger to enter a corresponding third-party application interface, and the function menu item is configured to trigger a corresponding function in the application scene to be executed.

It should be noted that, in the embodiment of the present disclosure, the function menu item in each application scene is configured to trigger the corresponding function in the application scene to be executed, and by binding the menu items to the application scene, the menu items displayed in the application menu are more suitable for each current application scene, so that the user is not desired to switch the menus many times for using any certain function in the application scene. That is, the use of the function can be achieved by directly triggering the function menu item, thereby improving the interaction experience and the efficiency of the user.

In some implementations, the application menu in the embodiment of the present disclosure mainly includes any one or more of following four types of menu items including a first type of menu items to a fourth type of menu items.

The first type of menu items include a plurality of system menu items corresponding to the operating system.

In some implementations, the system menu item may trigger a related function, such as setting, return, volume adjustment, information source switching and the like, in the homepage of the operating system or the Home application to be executed. Alternatively, the system menu item is configured to trigger a system function, such as return, home page, setting, information source switching, network setting, annotation, spotlight, screen capture, timer, voter, and the like, to be executed.

The second type of menu items include a plurality of application menu items corresponding to the application.

In some implementations, the application menu item may trigger to start and enter the third-party application interface, so that rapid switching and jumping between different applications can be realized, which facilitates the user rapidly jumping to another application during operating in an application.

The application menu item in the embodiment of the present disclosure is configured to trigger to enter a corresponding application interface. For example, the application menu item includes, but is not limited to, at least one of “workbench”, “browser”, “writing software”, “WPS”. It should be understood that the application menu in the embodiment of the present disclosure is a shortcut for entering the application, that is, if the user performs a touch operation on the application menu, the application interface corresponding to the application menu is started and entered.

A plurality of shortcut applications may be selected from predefined shortcut applications, and a plurality of application menu items corresponding to the selected shortcut applications are displayed in the application menu.

The third type of menu items include a function menu item corresponding to a function included in the application.

In some implementations, the function menu item may trigger a related function in the third-party application to be executed. For example, pen shape switching, handwriting color switching and other functions may be executed in the writing software.

The fourth type of menu items include a user-defined action option.

The action option is obtained by recording an operation input by the user through a record function.

The application menu may further include one or more preset menu items, common menu items to be displayed may be predefined and displayed, as the preset menu items, according to an operation expectation of the user, a function coverage of the application scene, other applications that may be called in the application scene, and the like, which is not limited in the embodiment of the present disclosure.

In some implementations, the menu items include two first menu items and one second menu item, one first menu item is configured to display the system menu item, the other first menu item is configured to display the application menu item, and the second menu item is configured to display the function menu item.

In some implementations, the menu items include one first menu item and two second menu items, the first menu item is configured to display the system menu item, one second menu item is configured to display the application menu item, and the other second menu item is configured to display the function menu item.

In some implementations, the menu items include one first menu item and one second menu item, and specifically include any one of following two display modes including a first display mode and a second display mode.

In the first display mode, the first menu item is configured to display the system menu item or the application menu item, and the second menu item is configured to display the function menu item.

In some implementations, the application scene is the Home application, the first menu item is configured to display the system menu item, and the second menu item is configured to display the application menu item.

In some implementations, in response to a user's start triggering operation on the displayed application menu item in the Home application, the third-party application corresponding to the application menu item is started.

In the second display mode, the first menu item is configured to display the system menu item and the second menu item is configured to display the application menu item.

In some implementations, the application scene is the non-Home application, the first menu item is configured to display the system menu item or the application menu item, and the second menu item is configured to display the function menu item.

In some implementations, the application menu includes a first menu and a second menu, and the menu triggering operation includes a first triggering operation and a second triggering operation, the first menu is displayed in response to the first triggering operation triggered by the user in the application scene, the second menu is displayed in response to the second triggering operation triggered by the user in the first menu, the first triggering operation is the same for different application scenes, and the second triggering operation is the same for different application scenes.

In some implementations, the first triggering operation may be a single-finger or multi-finger long-press operation, and the second triggering operation may be a single-finger or multi-finger sliding operation, for example, the second menu is triggered to be displayed by sliding left or right on the first menu.

In some implementations, the first menu is configured to display the first menu item to be the same for different application scenes, and the second menu is configured to display the second menu item to be different for different application scenes; or the first menu is configured to display the second menu item to be different for different application scenes, and the second menu is configured to display the first menu item to be the same for different application scenes.

In some implementations, the application menu in the embodiment of the present disclosure includes, but is not limited to, at least one of a sidebar menu or a tool palette menu, and the menu display method provided in the embodiment of the present disclosure is applicable to any type of menu, which is not limited in the embodiment of the present disclosure.

In a first case, the application menu is the sidebar menu.

In some implementations, the application menu in the embodiment of the present disclosure is the sidebar menu, including at least one first menu item and at least one second menu item, the first menu item is displayed by the application menu to be the same for different application scenes, and the second menu item is displayed by the application menu to be different for different application scenes.

In some implementations, the sidebar menu may be triggered to be displayed by a click operation except for the menu triggering operation in the embodiment of the present disclosure. For example, the sidebar menu is to be displayed by clicking an “arrow” on a side of a display screen.

In some implementations, the sidebar menu includes a first menu and a second menu arranged left and right or up and down.

In some implementations, the first menu is configured to display the first menu item, and the second menu is configured to display the second menu item, the first menu is configured to display the first menu item to be the same for different application scenes, and the second menu is configured to display the second menu item to be different for different application scenes; or, the first menu is configured to display the second menu item to be different for different application scenes, and the second menu is configured to display the first menu item to be the same for different application scenes.

In some implementations, the first menu item is configured to display the system menu item or the application menu item, and the second menu item is configured to display the function menu item; or, the first menu item is configured to display the system menu item, and the second menu item is configured to display the application menu item.

In some implementations, the application scene is the Home application, the first menu is configured to display a plurality of system menu items, and the second menu is configured to display a plurality of application menu items, the plurality of application menu items displayed in the second menu include at least one application menu item corresponding to another application other than the application of the current application scene, for triggering a function of jumping to the another application in the current application scene.

It should be noted that the application menu item in the embodiment of the present disclosure is configured to trigger to jump to an application corresponding to the application function menu item, and the application function menu item in the embodiment of the present disclosure is configured to trigger to use a function of the application corresponding to the application function menu item in the current application scene.

In some implementations, the application scene is the non-Home application, the first menu is configured to display a plurality of system menu items or a plurality of application menu items, and the second menu is configured to display a plurality of function menu items, the plurality of application menu items displayed in the first menu may further include at least one application menu item corresponding to another application other than the application displayed on the current interface.

In some implementations, the first menu is further configured to display a plurality of preset menu items, and the second menu is configured to display a plurality of function menu items; or, the second menu is configured to display the plurality of preset menu items, and the first menu is configured to display the plurality of function menu items. In this case, the plurality of function menu items displayed by the first menu or the second menu may further include at least one application menu item corresponding to another application other than the application of the current application scene.

In some implementations, the first menu is configured to display at least one of the system menu item or the application menu item, and the second menu is configured to display a plurality of function menu items; or, the second menu is configured to display at least one of the system menu item or the application menu item, and the first menu is configured to display the plurality of function menu items. In this case, the application menu item displayed by the first menu or the second menu may be configured to trigger to jump to another application in the current application scene. Alternatively, at least one application menu item corresponding to another application other than the application of the current application scene may be included in the plurality of function menu items, which is not limited in the embodiment of the present disclosure.

In some implementations, the application scene is the Home application, in response to the menu triggering operation triggered by the user on the homepage of the operating system, the first menu item in the sidebar is configured to display the system menu item, and the second menu item is configured to display the application menu item.

In some implementations, the application scene is the non-Home application, in response to the menu triggering operation triggered by the user in the application, the first menu item in the sidebar is configured to display the system menu item or the application menu item, and the second menu item is configured to display the function menu item.

In some implementations, in response to a sliding operation performed by the user on the second menu, the d menu items displayed by the second menu are controlled to be hidden after moving along a sliding direction of the sliding operation, and at least one menu item is newly displayed in the second menu.

The sidebar in the embodiment of the present application may be flexibly changed according to the current application, so that the user can start the most desired function in the shortest time. In response to the application menu item being displayed in the sidebar, the user can conveniently call a function of another application by using the application menu item in the sidebar, so that the function of a toolbar of an all-in-one machine is expanded, the function hidden in the application is fully utilized, and a greater value is brought to the user.

FIG. 2 is a schematic diagram of a default sidebar of an existing intelligent display apparatus according to an embodiment of the present disclosure. As shown in FIG. 2, the content in the sidebar is fixed, and the menu items in the sidebar are also fixed, that is, in any application scene of the intelligent display apparatus and in any application, the content displayed in the sidebar and the menu items included in the sidebar are not changed.

FIG. 3 is a schematic diagram of a sidebar displayed in a writing software scene according to an embodiment of the present disclosure. As shown in FIG. 3, the sidebar includes a first menu 300 and a second menu 301, the first menu 300 is configured to display a plurality of system menu items, and the second menu 301 is configured to display function menu items such as “scan code for sign in”, “file fast transfer”, “OCR (Optical Character Recognition)”, “voter”, “timer”, “browser”, and display progress bars for adjusting brightness and sound.

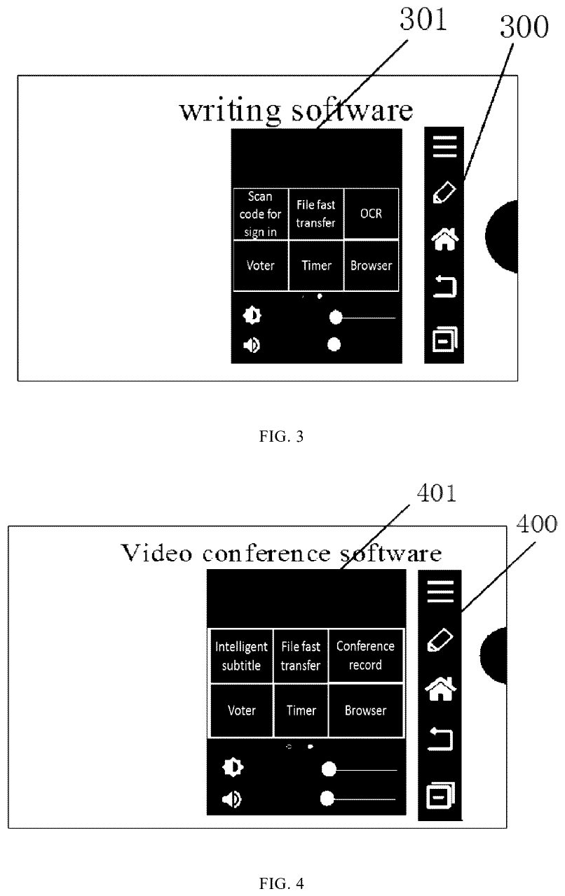

FIG. 4 is a schematic diagram of a sidebar displayed in a video conference software scene according to an embodiment of the present disclosure. As shown in FIG. 4, the sidebar includes a first menu 400 and a second menu 401, the first menu 400 is configured to display a plurality of system menu items, the second menu 401 is configured to display function menu items such as “intelligent subtitle”, “file fast transfer”, “conference record”, “voter”, “timer”, “browser”, and the like, and display progress bars for adjusting brightness and sound.

In the conference scene, during the user using video conference software, the most common operations include file viewing and conference decision voting, and since real-time translation is desired for a transnational conference, an intelligent subtitle function may be further included.

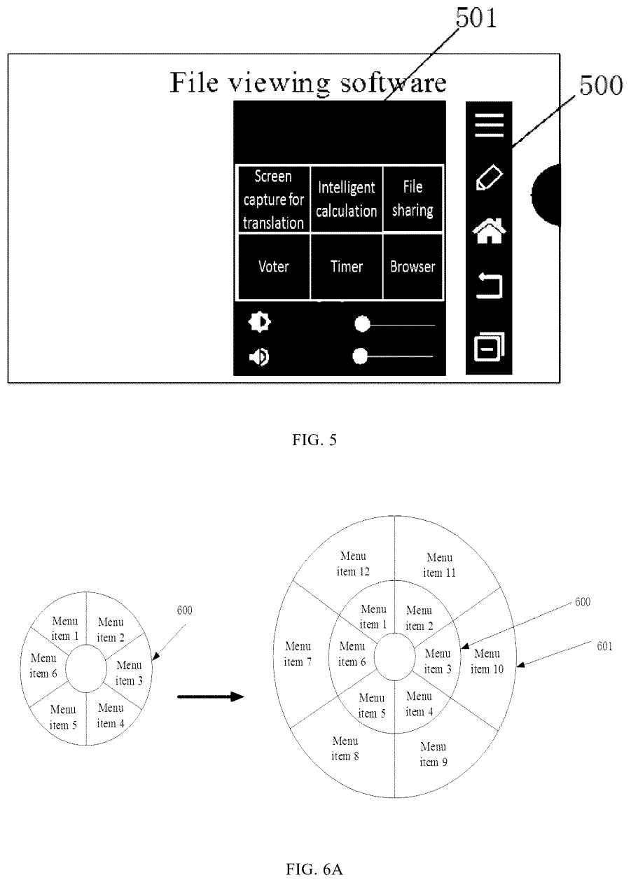

FIG. 5 is a schematic diagram of a sidebar displayed in a file viewing software scene according to an embodiment of the present disclosure. As shown in FIG. 5, the sidebar includes a first menu 500 and a second menu 501, the first menu 500 is configured to display a plurality of system menu items, the second menu 501 is configured to display function menu items such as “screen capture for translation”, “intelligent calculation”, “file sharing”, “voter”, “timer”, “browser”, and the like, and may further display progress bars for adjusting brightness and sound.

During the user viewing files, the user may read foreign language materials, and in a case where data in an excel document is great in volume, the function of intelligent calculation may be provided, and a column of data may be selected to be summarized or averaged or the like.

The “screen capture for translation”, the “intelligent calculation”, the “OCR” and the like are functions in the writing software. In the program design, the functions of the “screen capture for translation”, the “intelligent calculation” and the like in the writing software are modularized and are decoupled from the writing software, so that the functions in the writing software may be called even if the writing software is not started. Therefore, the functions (also called tools) may be used during the whiteboard software being used, or may be called from the sidebar in combination with the scenes, so that the tools in the sidebar has excellent expansion capability, and the user can expand tools of the sidebar by installing other applications, so as to provide more functions.

At least one application menu is displayed in response to a menu triggering operation triggered by the user in a scene of any intelligent display apparatus connected in a local area network, a plurality of intelligent display apparatuses are connected in the local area network, the application menu further includes a screen sharing menu item for triggering the content displayed by any intelligent display apparatus to be synchronously displayed on other intelligent display apparatuses connected in the local area network.

The function corresponding to the screen sharing menu item comes from screen projection software built in the system, and if the screen projection software detects that another display apparatus exist in the network, the screen sharing menu item may be displayed in the application menu.

In some implementations, the sidebar menu may be changed according to a scene in which the intelligent display apparatus is used. For example, if a conference room is provided with only one intelligent display apparatus, the sidebar designed in the embodiment of the present disclosure is displayed by default. If the conference room is provided with a plurality of intelligent display apparatuses, for example, including a conference all-in-one machine and an intelligent television, the screen sharing menu item may be displayed in a sidebar of the conference all-in-one machine, and the user may share and display the content displayed on the conference all-in-one machine onto a screen of the intelligent television by clicking the screen sharing menu item.

In a second case, the application menu is the tool palette menu.

In some implementations, the application menu is the tool palette menu, the tool palette menu includes at least one first menu and at least one second menu, the first menu is a first annular region, and the second menu is a second annular region, and the first annular region is distributed around the second annular region, or the second annular region is distributed around the first annular region.

In some implementations, the first annular region and the second annular region are displayed based on different triggering operations. The first annular region is displayed in response to a first triggering operation triggered by the user in the application scene, and the second annular region is displayed in response to a second triggering operation triggered by the user in the first menu. The first triggering operation is the same for different application scenes, and the second triggering operation is the same for different application scenes. That is, the user is desired to perform two triggering operations, after the first triggering operation is performed, only the first annular region (i.e., the first menu) is displayed, and after the second triggering operation is performed, the second annular region (i.e., the second menu) is displayed.

In some implementations, the first triggering operation may be a click operation, a single-finger or multi-finger long-press operation, and the second triggering operation may be a click operation, a double-click operation, a sliding operation or any other operation performed in a central region of the first annular region or in the first annular region, which is not limited in the embodiment of the present disclosure.

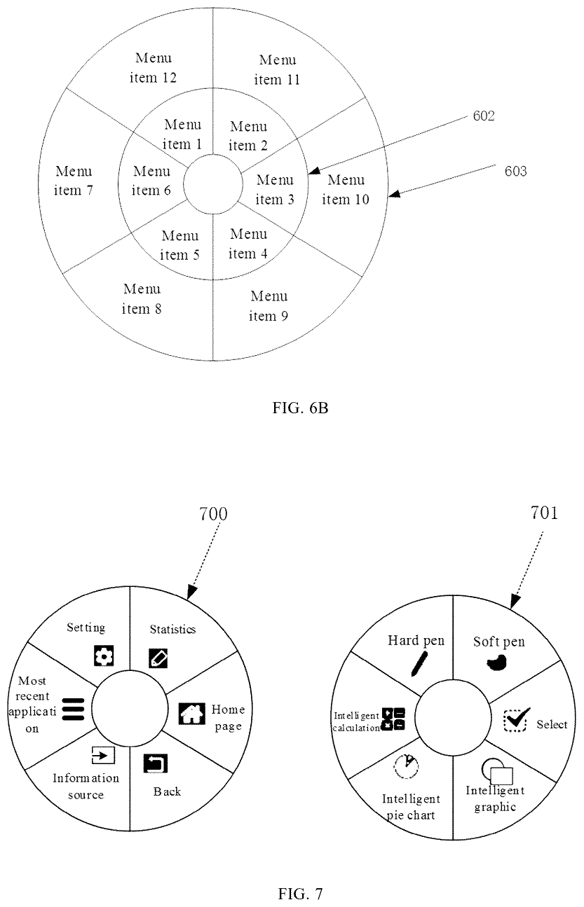

FIG. 6A is a schematic diagram of a tool palette menu according to an embodiment of the present disclosure. As shown in FIG. 6A, in response to the user performing the first triggering operation, a tool palette menu including a first annular region 600 is displayed, and if the user continues to perform the second triggering operation in the first annular region 600, a second annular region 601 is further displayed on the periphery of the first annular region 600. The first annular region 600 is configured to display a menu items of the first menu, and the second annular region 601 is configured to display menu items of the second menu.

In some implementations, the menu items (i.e., first menu items) displayed in the first annular region are not varied for different application scenes, and the menu items (i.e., second menu items) displayed in the second annular region are varied for different application scenes.

In some implementations, the first annular region is configured to display system menu items or application menu items, and the second annular region is configured to display application menu items or function menu items, the system menu item is configured to trigger a function built in the system to be executed, the application menu item is configured to trigger to enter a corresponding third-party application interface, and the function menu item is configured to trigger the corresponding function in the application scene to be executed.

In some implementations, the first annular region is configured to display the system menu items or the application menu items, and the second annular region is configured to display the function menu items. For example, the application scene is the non-Home application, the first annular region is configured to display the system menu items or the application menu items, and the second annular region is configured to display the function menu items.

In some implementations, the first annular region is configured to display the system menu items, and the second annular region is configured to display the application menu items. For example, the application scene is the Home application, the first annular region is configured to display the system menu items, and the second annular region is configured to display the application menu items.

In some implementations, the application menu is the tool palette menu, the tool palette menu includes a third annular region and a fourth annular region, the third annular region is distributed around the fourth annular region, or the fourth annular region is distributed around the third annular region, the third annular region is configured to display the first menu items the same for different application scenes, and the fourth annular region is configured to display the second menu items different for different application scenes; or the third annular region is configured to display the second menu items different for different application scenes, and the fourth annular region is configured to display the first menu items the same for different application scenes.

In some implementation, the third annular region and the fourth annular region are triggered to be displayed based on the same menu triggering operation. For example, after the single-finger long-press operation of the user, the tool palette menu is triggered to be displayed, and the tool palette menu displays the third annular region and the fourth annular region.

FIG. 6B is a schematic diagram of a tool palette menu according to an embodiment of the present disclosure. As shown in FIG. 6B, after the user performs the menu triggering operation, for example, after the single-finger or multi-finger long-press operation of the user, a tool palette menu including a third annular region 602 and a fourth annular region 603 is displayed.

In some implementations, in response to the application scene being a first application scene, the application menu includes a third menu, in response to the application scene being a second application scene, the application menu includes a fourth menu, at least one menu item displayed by the third menu is different from any menu item displayed by the fourth menu, and the menu triggering operation triggered in the first application scene is the same as the menu triggering operation triggered in the second application scene.

FIG. 7 is a schematic diagram of different application menus displayed in different application scenes according to an embodiment of the present disclosure. As shown in FIG. 7, by taking the tool palette menu as an example, in a Home application scene, a third menu 700 is displayed after the single-finger long-press operation of the user, and in a writing application scene, a fourth menu 701 is displayed after the single-finger long-press operation of the user, menu items in the third menu 700 are different from menu items in the fourth menu 701.

In some implementations, the third menu is displayed in response to the menu triggering operation triggered by the user in the first application scene, and the fourth menu is displayed in response to the menu triggering operation triggered by the user in the second application scene, at least one menu item displayed by the third menu is different from any menu item displayed by the fourth menu, and the menu triggering operation triggered in the first application scene is the same as the menu triggering operation triggered in the second application scene.

In some implementations, the first application scene is the Home application, and the second application scene is the non-Home application, such as the writing application, the third menu includes the system menu items and the fourth menu includes the function menu items.

In some implementations, a fifth menu is displayed in response to a triggering operation on the fourth menu by the user, at least one menu item displayed by the fifth menu is the same as at least one menu item displayed by the third menu, and the fifth menu includes the system menu items. For example, in the embodiment of the present disclosure, the triggering operation on the fourth menu by the user includes, but is not limited to, one of a single click operation, a double-click operation or a sliding operation.

In some implementations, the tool palette menu further includes a central region located in a center of the first annular region, and the central region is configured to trigger an operation corresponding to the menu item to be executed.

In some implementations, the tool palette menu includes a central region, a first annular region surrounding the central region and a second annular region surrounding the first annular region, and the central region is configured to trigger the operation corresponding to the menu item to be executed.

In some implementations, the central region is configured to display an edit menu item, and trigger the menu item in the tool palette menu and/or the application scene to be edited.

In some implementations, the central region may not display any content, and only has the function of triggering the operation corresponding to the menu item to be executed, for example, triggering the menu items displayed in the tool palette menu to be edited. The central region may display “more” or any other content as the edit menu item, which is not limited by the embodiment of the present disclosure.

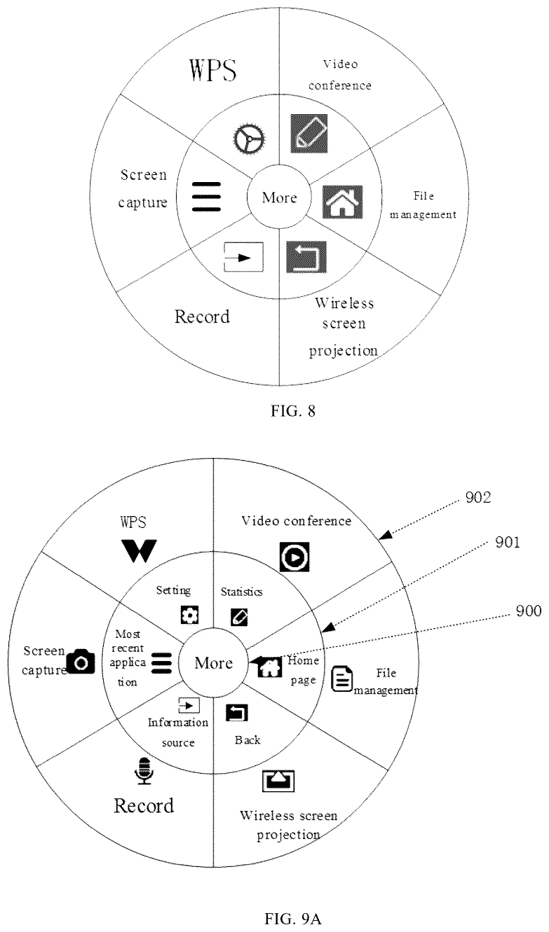

FIG. 8 is a schematic diagram of a tool palette menu according to an embodiment of the present disclosure. As shown in FIG. 8, as an example, the tool palette menu includes two annular menus, the central region displays “more” and the user clicks the “more” to enter an editing interface of the menu items, so that any one or more menu items displayed in the tool palette menu can be edited by an editing operation. The editing operation includes operations such as adding a new menu item, deleting any displayed menu item, or modifying any menu item or the like.

It should be noted that each menu item displayed in the tool palette menu in the embodiment of the present disclosure may be displayed in a form of a text and/or an icon, which may be specifically customized and is not limited in the embodiment of the present disclosure.

In some implementations, the tool palette menu includes the first annular region surrounding the central region and the second annular region surrounding the first annular region.

In some implementations, the first annular region is configured to display a plurality of system menu items, the second annular region is configured to display a plurality of application menu items; or the second annular region is configured to display a plurality of system menu items, the first annular region is configured to display a plurality of application menu items.

In response to the menu triggering operation triggered by the user on the homepage of the operating system, the first annular region is configured to display the plurality of system menu items and the second annular region is configured to display the plurality of application menu items. The system menu items include, but are not limited to, “return”, “accumulation”, “homepage”, “setting”, “information source”, “most recent application”, and the like, which are not limited in the embodiment of the present disclosure.

In some implementations, the first annular region and the second annular region display different contents, specifically as any one or more of following four cases.

In a first case, the first annular region is configured to display a plurality of function menu items, the second annular region is configured to display a plurality of system menu items.

In a second case, the first annular region is configured to display a plurality of function menu items, the second annular region is configured to display a plurality of application menu items.

In a third case, the second annular region is configured to display a plurality of function menu items, the first annular region is configured to display a plurality of system menu items;

In a fourth case, the second annular region is configured to display a plurality of function menu items, the first annular region is configured to display a plurality of application menu items.

In some implementations, the central region in the embodiment of the present disclosure may have two different functions (e.g., called a first function and a second function) as follows.

In the first function, the central region is configured to display the edit menu item and trigger the menu item in the annular regions and/or the application scene to be edited.

In some implementations, in response to a menu triggering operation triggered by the user in an application scene other than the writing software, the central region is configured to display the edit menu items, and the user can edit the application scene and can also edit function menu items corresponding to the application scene.

In the second function, the central region is configured to display the menu sub-item of the menu item in the annular regions and trigger functions of the menu sub-items to be executed.

In some implementations, the central region is configured to display menu sub-items of function menu items in the annular regions, or menu sub-items of system menu items in the annular regions or menu sub-items of application menu items in the annular regions, which is not limited in the embodiment of the present disclosure.

In some implementations, in response to a menu triggering operation triggered by the user in the writing software, the central region is configured to display the menu sub-items of the function menu items corresponding to the writing software.

For example, if the function menu item is “handwriting”, the menu sub-items corresponding to the function menu item include one or more handwriting parameters. For example, if the function menu item is “stylus”, the menu sub-items corresponding to the function menu item include one or more stylus parameters, including a color, a track thickness, a transparency, and the like of the stylus. For example, if the function menu item is “eraser”, the menu sub-items corresponding to the function menu item include one or more eraser parameters, including a size, a shape, and the like.

In some implementations, the central region is configured to display the edit menu items in response to a menu triggering operation triggered by the user in an application scene other than the writing software.

In some implementations, the tool palette menu is to be displayed by: displaying a suspended menu control; and displaying the application menu corresponding to the application scene in response to a triggering operation of the user on the suspended menu control.

In some implementations, the suspended menu control includes, but is not limited to, a suspended ball.

In some implementations, the application menu is the tool palette menu, including a central region and at least one annular region surrounding the central region, in response to the menu triggering operation triggered by the user in the application scene, the suspended menu control is displayed firstly, and then the tool palette menu is completely displayed.

In some implementations, regions in the tool palette menu are displayed sequentially by: sequentially displaying the central region and the at least one annular region of the tool palette menu from inside to outside or from outside to inside in response to a first triggering operation of the user on the suspended menu control; or, sequentially displaying the central region and the at least one annular region of the tool palette menu from inside to outside or from outside to inside in response to a sliding operation of the user on the suspended menu control.

In some implementations, the regions in the tool palette menu are displayed sequentially by: displaying the central region of the tool palette menu in response to a second triggering operation of the user on the suspended menu control, and sequentially displaying the at least one annular region of the tool palette menu from inside to outside or from outside to inside in response to a third triggering operation of the user on the central region.

In some implementations, the user performs the second triggering operation on the suspended menu control to display the central region, and then performs the third triggering operation on the central region to display the at least one annular region. For example, the second triggering operation includes a click operation, a double-click operation, or a long-press operation, or the like, and the third triggering operation includes a sliding operation, including at least one of a left sliding, a right sliding, an up sliding, or a down sliding.

In some implementations, the at least one annular region of the tool palette menu includes a plurality of block sub-regions displaying the menu items in one-to-one correspondence, and the tool palette menu may be displayed by: sequentially displaying the block sub-regions of the at least one annular region in a clockwise direction or a counterclockwise direction during displaying the at least one annular region.

In some implementations, after displaying the tool palette menu, the method further includes: switching displaying the tool palette menu to displaying the suspended menu control in response to a touch operation of the user on the central region of the tool palette menu; moving the tool palette menu to a position corresponding to a dragging instruction in response to the dragging instruction of the user on the suspended menu control.

In some implementations, the touch operation includes, but is not limited to, a click operation, a double-click operation, a long-press operation, and the like, which is not limited in the embodiment of the present disclosure.

In some implementations, after displaying the tool palette menu, the method may further include: displaying the tool palette menu at a pressed position of the screen (at which the screen is pressed) in response to a press operation pressing the screen formed by the user with a single finger or multiple fingers; in response to a sliding operation formed by the user sliding from the pressed position of the screen stops, executing a function of the menu item corresponding to a position at which the sliding operation stops.

In some implementations, a position at which the tool palette menu is displayed is determined according to the pressed position of the screen pressed by the user with a single finger or multiple fingers, a starting point of the sliding operation is at the pressed position, an end point of the sliding operation is at the menu item in the annular region of the tool palette menu, and the menu item corresponding to the sliding operation is the menu item corresponding to the end point. Specifically, the user presses the screen with a single finger or multiple fingers to enable the tool palette menu to be displayed, and then the user directly slides the finger to a block-shaped region where any menu item in the annular region of the tool palette menu is located without lifting up the finger, so that the function of the menu item in the block-shaped region is started.

In some implementations, the central region of the tool palette menu is displayed at the pressed position of the screen, and in response to the sliding operation formed by the user sliding from the pressed position of the screen stops, the function of the menu item displayed in the annular region corresponding to the position at which the sliding operation stops is executed.

In some implementations, after the function of the menu item corresponding to the position at which the sliding operation stops is executed, the tool palette menu may be further controlled to be hidden.

In some implementations, after the tool palette menu is displayed, if no touch operation of the user on the tool palette menu is received within a preset time, the tool palette menu may be further controlled to be hidden.

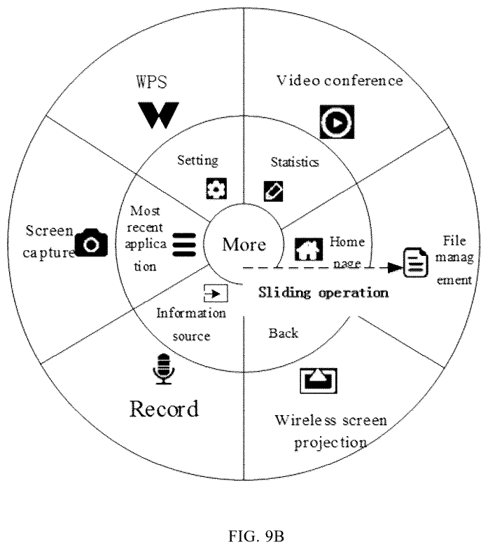

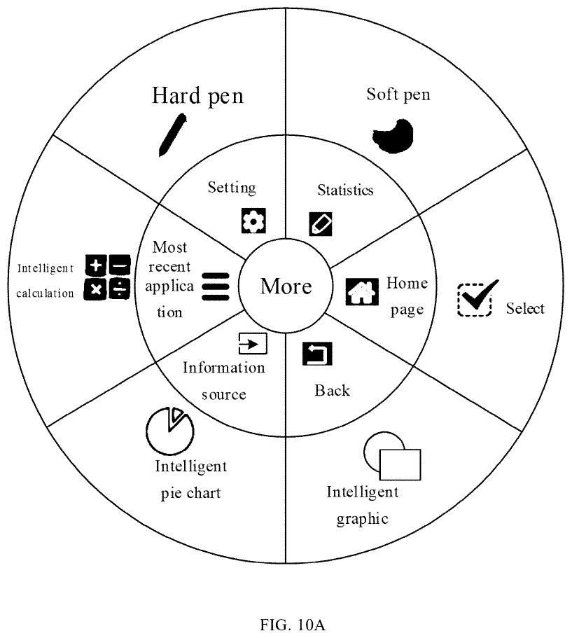

FIGS. 9A to 9B are schematic diagrams of a tool palette menu according to an embodiment of the present disclosure. As shown in FIGS. 9A to 9B, the tool palette menu includes a central region 900, a first menu (a first annular region) 901, and a second menu (a second annular region) 902.

In FIG. 9A, the user presses the screen with a single finger for a long time to form a pressing operation, and the tool palette menu is displayed at the pressed position of the screen. For example, if the pressed position of the screen is located at the edge of the display screen of the intelligent display apparatus, that is, the tool palette menu cannot be completely displayed, the position of the tool palette menu may be automatically adjusted, so that the tool palette menu is moved to a position where the tool palette menu can be completely displayed.

In FIG. 9B, after the user presses the screen with a single finger for a long time and the tool palette menu is displayed, the user may directly call the function of the menu item or activate the menu item as desired by lifting up the finger after directly sliding the finger from the pressed position of the screen to the menu item without lifting up the finger.

After the user presses the screen with a single finger for a long time and the tool palette menu is displayed, the tool palette menu may disappear (or be hidden) after the user clicking an external region where the tool palette menu is not located or after a preset time period in which no operation is performed. For example, if 8 seconds elapse without any operation, the menu disappears (or is hidden).

In some implementations, the menu items displayed in the second annular region are varied for different application scenes, that is, in response to the menu triggering operation triggered by the user in different applications, the menu items in the second annular region of the tool palette menu displayed in the application are varied for different applications.

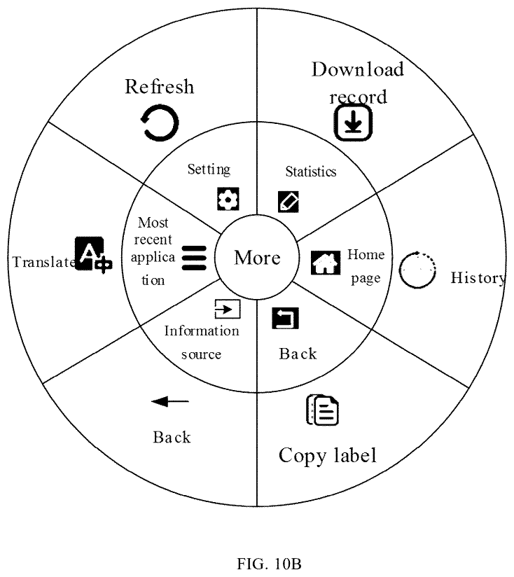

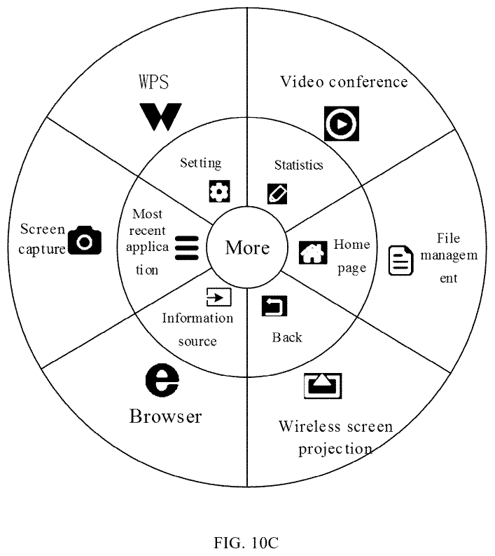

FIGS. 10A to 10C are schematic diagrams of tool palette menus displaying different menu items in different scenes according to an embodiment of the present disclosure. As shown in FIGS. 10A to 10C, FIG. 10A is a schematic diagram of a tool palette menu displayed in the writing software, the second annular region includes function menu items such as “hard pen”, “soft pen”, “select”, “intelligent graphic”, “intelligent pie chart”, and “intelligent calculation” and the like, and the first annular region includes a plurality of system menu items. FIG. 10B is a schematic diagram of a tool palette menu displayed in a browser, the second annular region includes function menu items such as “refresh”, “download record”, “history”, “copy label”, “back”, “translate”, and the like, and the first annular region includes a plurality of system menu items. FIG. 10C is a schematic diagram of a tool palette menu displayed in other general scenes, such as video conference, file management, wireless screen projection, sound recording, screen capturing, WPS, or the like, the second annular region includes a plurality of application menu items, such as applications like “file management”, “screen capture”, “browser”, “WPS”, etc., and the first annular region includes a plurality of system menu items.

The function menu items in the second annular region of the tool palette menu being varied for different applications may be realized by: in response to receiving the menu triggering operation triggered by the user in the application, acquiring a list of programs to be used by the user in the application through a UsageStatsManager, then ordering the programs according to recent timings using the programs, to obtain a packet name of the current front-end application, and displaying corresponding menu items according to locally recorded menu items (including but not limited to function menu items) set by the user in the front-end application. The functions of the corresponding menu items may be realized by triggering a click operation to call a ready-made tool implementation interface or by an assistant click through an auxiliary service (Accessibility Service). The UsageStatsManager is configured to inquire usage details, configuration details and event log data of the applications.

In some implementations, the central region of the tool palette menu in the embodiment of the present disclosure is configured to display an edit menu item, such as “more”, and trigger the menu item in the annular regions and/or the application scene to be edited by an editing operation. The editing operation on the menu item includes editing the application scene, and editing the function menu item.

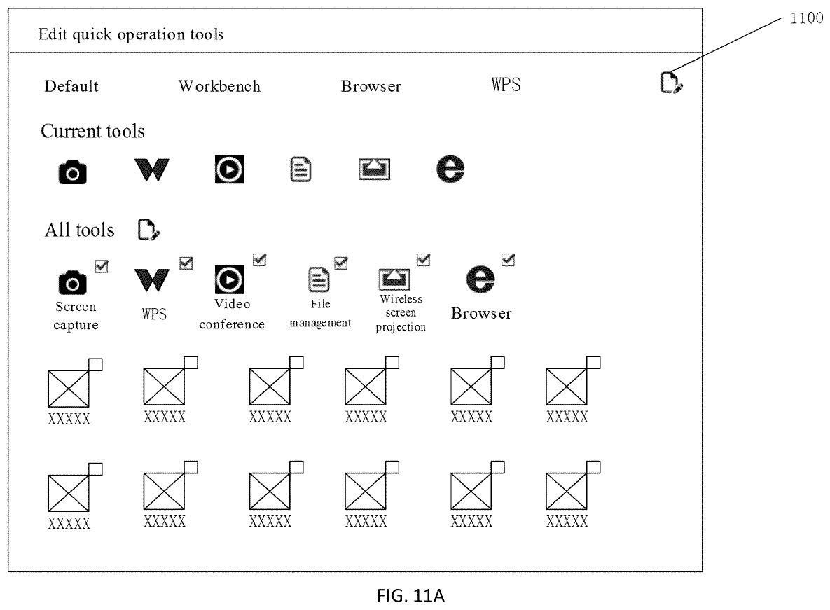

FIG. 11A is a schematic diagram of an editing interface of a menu item according to an embodiment of the present disclosure. As shown in FIG. 11A, for example, the user clicks “more” displayed in the central region to enter the editing interface for editing the menu items, and may select any application scene, click an “edit button” 1100 in the application scene, and edit the corresponding function menu item in the selected application scene. FIG. 11B is a schematic diagram of an editing interface of an application scene according to an embodiment of the present disclosure. As shown in FIG. 11B, on the editing interface displaying the menu items, the user may click the “edit button” 1100 at the upper right corner in FIG. 11A to edit the application scene, and enter the editing interface for editing the application scene as shown in FIG. 11B. During editing, the application scene such as “default”, “workbench”, “browser”, or “WPS” or the like may be selected, or other application scenes may alternatively be added. Applications pre-installed in the intelligent display apparatus may be used as the application scenes. The pre-defined function menu items become effective in response to that the corresponding application is started, and general menu items are displayed in the tool palette menu if other application scenes are called. The quick operation of the tool palette menu is adjusted by selecting the menu item desired to be called quickly, at most a preset number of menu items may be selected simultaneously, and the menu items to be selected may include default menu items and action options recorded by the user.

FIG. 12 is a schematic diagram illustrating a function of a user-defined action option according to an embodiment of the present disclosure. As shown in FIG. 12, the user may click an “edit button” 1100 in FIG. 11A to display and select a user-defined action option, and enter a customizing interface to present existing actions, the existing actions are all actions that have been created or defined by the user, and are ordered in reverse order according to time sequences. The operations such as play, rename, delete, and edit may also be performed on the existing actions. In editing, after clicking the edit button, the details of each action are presented. For example, the user records an operation of drawing a small house on a workbench, including three steps, that is, inserting a basic circle, and drawing two pieces of handwriting, and these steps may be respectively modified, including modifying color attributes, a position relationship between key points of the handwriting, or re-recording the handwriting, or the like.

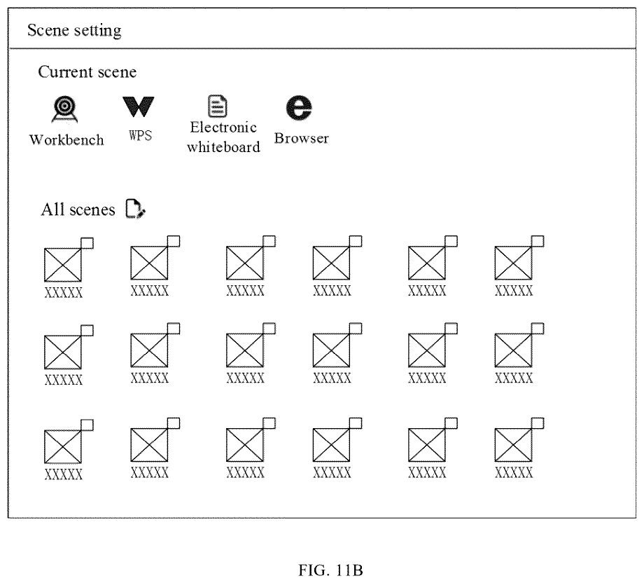

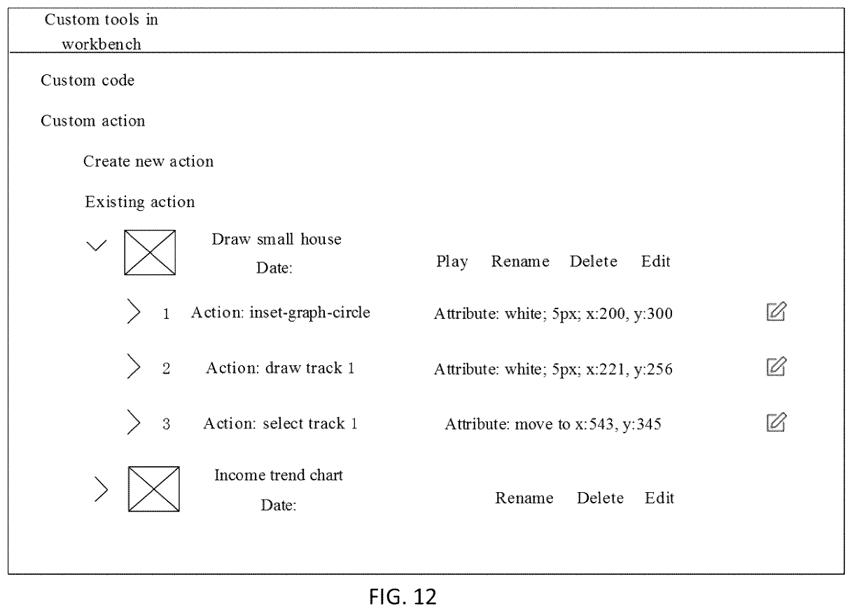

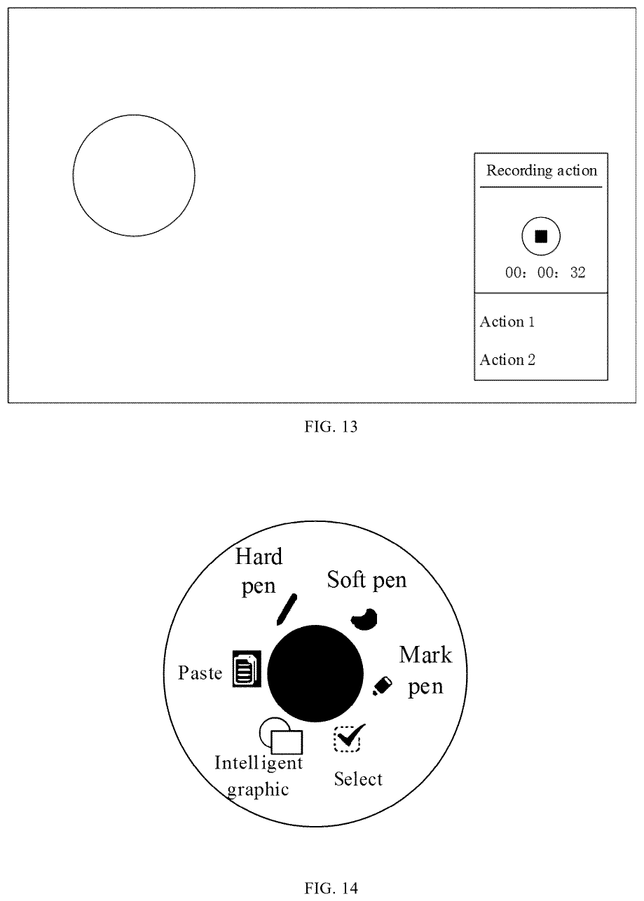

FIG. 13 is a schematic diagram of creating a new action according to an embodiment of the present disclosure. As shown in FIG. 13, the user may click a “new action” button in FIG. 12, so that an action recording window is popped up as shown in FIG. 13, then the user clicks a “start” button to start recording, and all the subsequent operations are recorded, and in response to that the user clicks the button again to stop recording, the recorded actions are recorded in a lower panel and are also synchronized to the “existing actions” in FIG. 12.

FIG. 14 is a schematic diagram of a tool palette menu displayed within writing software according to an embodiment of the present disclosure. As shown in FIG. 14, the tool palette menu includes a central region 1400 and an annular region 1401 surrounding the central region, and the user may trigger a menu triggering operation in the writing software to display the tool palette menu, the menu triggering operation includes a single-finger or multi-finger long-press operation. A plurality of function menu items, including but not limited to “hard pen”, “soft pen”, “mark pen”, “select”, “paste”, “intelligent graphic”, and the like, may be displayed in the annular region 1401, and the user may select the hard pen or the soft pen or the mark pen. The “select” is configured to switch or change the function to be selected, the “paste” is configured to paste the copied content in the current page, the same element may be pasted only once, and the “intelligent graphic” is configured to recognize the graphic hand-drawn by the user as an intelligent graphic, the handwriting of the graphic hand-drawn by the user may be recognized only once, and if the next recognition is carried out, the intelligent graphic is to be re-clicked. If the user clicks a dot in the central region 1400, the tool palette menu may be returned to the initial position. The user may close or hide the tool palette menu by clicking any region outside the tool palette menu.

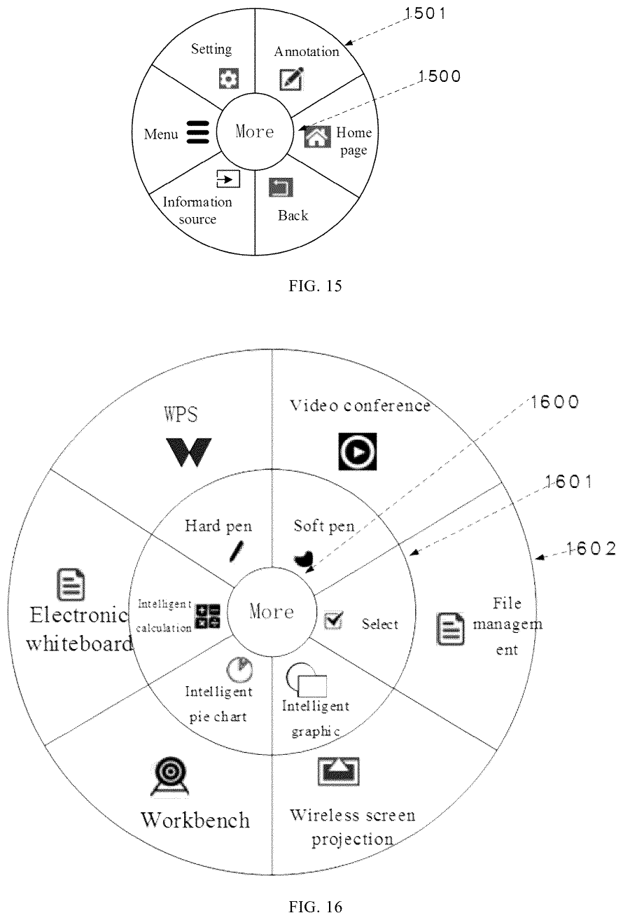

FIG. 15 is a schematic diagram of a tool palette menu displayed in a system homepage (Home application) scene according to an embodiment of the present disclosure. As shown in FIG. 15, the user may trigger a menu triggering operation on the homepage of the operating system, and the tool palette menu is displayed, the tool palette menu includes a central region 1500 and an annular region 1501 surrounding the central region, the central region 1500 displays “more”, and the annular region 1501 is configured to display a plurality of system menu items, including “homepage”, “return”, “information source”, “annotation”, and “menu”. The user may click the “more” to enter the editing interface for the system menu items, and the menu items may be in a locked state or in an unlocked state. The menu items in the locked state are menu items fixedly displayed in the tool palette menu, the user may click a lock icon on the editing interface to switch the states of the menu items, and the number of the menu items in the locked state is at most 5. If the number of the menu items in the locked state exceeds 5, a prompt box 1 is popped up to prompt the user to select at most 5 tools. If 5 menu items are in the locked state, a determination button becomes effective, and if the number of the menu items in the locked state is less than 5, a prompt box 2 is popped up for prompting the user to select 5 tools. The system menu items displayed in the tool palette menu are arranged in a clockwise direction from a position of 12 o'clock according to an order in which the menu items are locked. The user may also select whether to display the tool palette menu by sliding a switch button, or click any region outside the tool palette menu to close or hide the tool palette menu.

FIG. 16 is a schematic diagram of a tool palette menu displayed within writing software according to an embodiment of the present disclosure. As shown in FIG. 16, the tool palette menu includes a central region 1600, a first annular region 1601 and a second annular region 1602, the first annular region 1601 is configured to display function menu items such as hard pen, soft pen, select, intelligent graphic, intelligent pie chart, and intelligent calculation. If it is desired to modify the function menu items, the user may click “more” in the central region 1600 to enter the editing interface. The second annular region 1602 is configured to display the application menu items such as video conference, file management, drawing board, more applications, file fast transfer, and workbench, and the application corresponding to the application menu item is to be started after the application menu item is clicked. The user may click any region outside the tool palette menu to close or hide the tool palette menu.

In some implementations, the tool palette menu is displayed in response to the menu triggering operation triggered by the user within the writing software, the method further includes: controlling a multi-person writing mode to be enabled or disenabled, in response to a touch operation of the user on the menu item of at least one annular region of the tool palette menu.

In some implementations, after the multi-person mode is enabled, the central region is further configured to trigger switching between sub-regions to be executed, and display the current sub-region distinguishing from other sub-regions, the sub-regions are obtained by dividing a writing region according to the number of writing persons, and the function menu items displayed in the at least one annular region are configured to control writing parameters of the current sub-region.

For example, the writing region is divided into left and right regions, up and down regions, quartered regions, or the like, which may be circularly switched by clicking the central region, and simultaneously, a schematic diagram of a position relationship between a handwriting region, to which the on-going handwriting attribute setting belongs, and a full screen is displayed, to clarify the division of the regions and the setting of the corresponding regions. By taking a left-right partition mode as an example, and a multi-person handwriting configuration mode is enabled, if the suspended menu control is clicked on the left half part of the screen, the setting such as color, handwriting thickness and the like is directed for the writing on the left half part of the screen, and is stored independently of the attributes configured for the writing on the right half part of the screen, and during the handwriting being drawn, the corresponding rendering attribute may be selected according to the region where a writing start point is located. Before the multi-person handwriting configuration mode is enabled, the parameters in a single-person writing mode may be stored, and if the multi-person handwriting configuration mode is disenabled, the drawing attributes may be automatically restored as the parameters in the single-person writing mode.

In some implementations, one or more application menus may be displayed in each application scene, and displaying a plurality of application menus may be applicable to a multi-person writing mode. For example, in the writing software scene, a plurality of application menus may be displayed for matching with a plurality of writing users during the plurality of writing users writing, so that the plurality of writing users can use the application menus respectively close thereto during they writing simultaneously, which improves the convenience of writing of the plurality of writing users, and operations such as setting the respective writing tracks of the plurality of writing users can be performed correspondingly through the respective application menus corresponding to the writing users, so that it is facilitated to distinguishing the writing tracks of the plurality of writing users from each other.

In some implementations, a plurality of tool palette menus are displayed in response to the menu triggering operation triggered by the user within the writing software, each tool palette menu corresponds to one sub-region, and is configured to control the writing parameters of the corresponding sub-region, or control the writing parameters of the writing track formed from the writing start point closest to the tool palette menu.

For example, a plurality of tool palette menus (e.g., two tool palette menus) as above may be generated, positions of the tool palette menus are different, and regions with the writing parameters controlled by the tool palette menus are different. For example, the two tool palette menus may control writing parameters, such as handwriting color, handwriting thickness and the like, of different display regions.

In the embodiment, the partitions of the writing region are not clearly defined, and in response to a certain operation of the user, the two tool palette menus are generated on the writing region, so that if the writing start point of the user is close to any tool palette menu during writing, the writing parameters corresponding to the tool palette menu are effective. That is, different writing parameters are configured for different tool palette menus, and the writing parameters are determined to be effective or ineffective according to a distance relationship between the writing start point of the user and the tool palette menu configured with the writing parameters.

Alternatively, writing regions controlled by the tool palette menus are determined based on a horizontal distance between the two tool palette menus, i.e., only the horizontal distance is taken into account. A horizontal middle line between the two tool palette menus serves as a dividing line for dividing regions to be controlled by the two tool palette menus. In particular, the generation of the multi-person writing mode may be further refined (e.g., the multi-person writing mode is not always enabled, because it may affect the recognition for some gestures).

In some implementations, displaying the tool palette menus in response to the menu triggering operation triggered by the user within the writing software includes: displaying the suspended menu control in response to the menu triggering operation triggered by the user in the writing software; displaying a selection box for displaying different numbers of writing persons in response to a fourth touch operation of the user on the suspended menu control; and starting the multi-person writing mode, and displaying the tool palette menus corresponding to the number of writing persons in response to a selection operation of the user on the number of writing persons in the selection box For example, a triggering operation for triggering the multi-person writing mode may be set. For example, the suspended menu control may be pressed for a long time, to generate the selection box, and the user may select two or three or four persons to write simultaneously, to sequentially, from left to right, generate the tool palette menus or suspended menu controls obtained by zooming out the tool palette menus on the entire screen, so that each tool palette menu controls the corresponding writing region, and the users can choose or modify the writing parameters, or hide the tool palette menus corresponding thereto.

In some implementations, the tool palette menu is displayed by: enabling the multi-person writing mode in response to the menu triggering operation triggered by a second user in the writing software during a first user writing in the writing software, and displaying the tool palette menu corresponding to the second user, the tool palette menu corresponding to the second user being configured to control the writing parameters of the sub-region corresponding to the second user, and the sub-region corresponding to the first user being different from the sub-region corresponding to the second user.

In such mode, if a triggering instruction for triggering the tool palette menu (for example, a 5-finger press operation for triggering the tool palette menu to be displayed) is detected during the first user is writing, the multi-person writing mode may be enabled, and simultaneously the tool palette menu is displayed. The second user may modify the writing parameters through the tool palette menu, but the writing parameters are only applicable in the writing region controlled by the tool palette menu, or in the writing region close to the tool palette menu.

In some implementations, the tool palette menu is displayed by: receiving the menu triggering operation triggered by a finger and a stylus in the writing software, enabling the multi-person writing mode, and displaying a first tool palette menu corresponding to the finger and a second tool palette menu corresponding to the stylus, the first tool palette menu being configured to control the writing parameters of the sub-region corresponding to the finger, and the second tool palette menu being configured to control the writing parameters of the sub-region corresponding to the stylus.

In such mode, in the existing conference all-in-one machine generally supporting two writing modes (which may be understood as the multi-person writing mode) using the finger and the stylus, different writing parameters are configured for the finger and the stylus. If the finger touching the screen is detected, the first tool palette menu is triggered and configured to control the writing parameters corresponding to the finger to be modified. If the triggering of the stylus is detected, the second tool palette menu is triggered and configured to control the writing parameters corresponding to the stylus to be modified.

Based on the same inventive concept as above, an embodiment of the present disclosure further provides an intelligent display apparatus, since the apparatus is an apparatus for implementing the method in the embodiment of the present disclosure, the principle of the apparatus to solve the technical problem is similar to that of the method described above. Thus, the implementation of the apparatus may refer to the implementation of the method described above, and the repeated contents are not described here again.

It should be noted that the intelligent display apparatus in the embodiment of the present disclosure refers to a large-sized (generally, more than 50 inches) intelligent interactive display apparatus with a touch handwriting function. The intelligent display apparatus is installed with a writing program such as an electronic whiteboard, the user may write on the display apparatus by using a finger, an active stylus or a passive stylus or the like, and the intelligent display apparatus may include a display module or display screen such as a liquid crystal display (LCD), an organic electroluminescence display, and an electronic ink screen, and further includes a touch component, which includes, but is not limited to, an infrared or capacitive touch component, or the like, so that the handwriting may be displayed in real time. The controller of the intelligent display apparatus is installed with an operating system, including, but not limited to Android, Windows or the like.

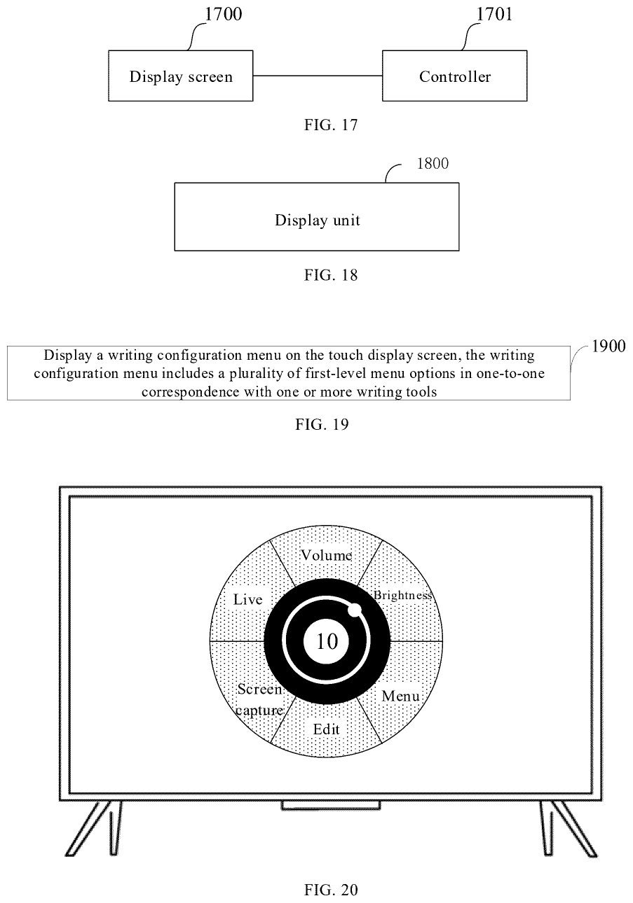

As shown in FIG. 17, the apparatus includes a display screen 1700 and a controller 1701.

The display screen 1700 is configured to display a content.

The controller 1701 is configured to: display an application menu corresponding to an application scene in response to a menu triggering operation triggered by a user in the application scene, the application menu is configured to display a plurality of menu items, the menu triggering operation is the same for different application scenes, and at least part of the menu items are displayed to be different for different application scenes.

In some implementations, the menu items includes at least one first menu item and at least one second menu item, the first menu item is displayed by the application menu to be the same for different application scenes, and the second menu item is displayed by the application menu to be different for different application scenes.

In some implementations, the at least one first menu item is configured to display a system menu item or an application menu item, the at least one second menu item is configured to display an application menu item or a function menu item, the system menu item is configured to trigger a function built in the operating system to be executed, the application menu item is configured to trigger to enter a corresponding third-party application interface, and the function menu item is configured to trigger the corresponding function in the application scene to be executed.

In some implementations, the first menu item is configured to display the system menu item or the application menu item, and the second menu item is configured to display the function menu item; or the first menu item is configured to display the system menu item, and the second menu item is configured to display the application menu item.

In some implementations, the application scene is a Home application, the first menu item is configured to display the system menu item, and the second menu item is configured to display the application menu item.

In some implementations, the controller 1701 is configured to: start a third-party application corresponding to the application menu item in response to a user's start triggering operation on the application menu item in the Home application.

In some implementations, the application scene is a non-Home application, the first menu item is configured to display the system menu item or the application menu item, and the second menu item is configured to display the function menu item.

In some implementations, the application menu includes a first menu and a second menu, and the menu triggering operation includes a first triggering operation and a second triggering operation; the controller 1701 is configured to: display the first menu in response to the first triggering operation triggered by the user in the application scene; display the second menu in response to the second triggering operation triggered by the user in the first menu; the first triggering operation is the same for different application scenes, and the second triggering operation is the same for different application scenes.

In some implementations, the first menu is configured to display the first menu item to be the same for different application scenes, and the second menu is configured to display the second menu item to be different for different application scenes; or the first menu is configured to display the second menu item to be different for different application scenes, and the second menu is configured to display the first menu item to be the same for different application scenes.

In some implementations, the application menu is a sidebar menu, and the first menu and the second menu are arranged left and right or up and down.

In some implementations, the application menu is a tool palette menu, the first menu is a first annular region, the second menu is a second annular region, and the first annular region is distributed around the second annular region, or the second annular region is distributed around the first annular region.

In some implementations, the application menu is a tool palette menu, the tool palette menu includes a third annular region and a fourth annular region, and the third annular region is distributed around the fourth annular region, or the fourth annular region is distributed around the third annular region; the third annular region is configured to display the first menu item to be the same for different application scenes, and the fourth annular region is configured to display the second menu item to be different for different application scenes; or the third annular region is configured to display the second menu item to be different for different application scenes, and the fourth annular region is configured to display the first menu item to be the same for different application scenes.

In some implementations, in response to the application scene being a first application scene, the application menu includes a third menu, and in response to the application scene being a second application scene, the application menu includes a fourth menu, at least one menu item displayed by the third menu is different from any menu item displayed by the fourth menu, and the menu triggering operation triggered in the first application scene is the same as the menu triggering operation triggered in the second application scene.

In some implementations, the controller 1701 is configured to display a fifth menu in response to a triggering operation on the fourth menu by the user, at least one menu item displayed by the fifth menu is the same as at least one menu item displayed by the third menu.

In some implementations, the tool palette menu further includes a central region located in a center of the first annular region, and the central region is configured to trigger an operation corresponding to the menu item to be executed.

In some implementations, the central region is configured to display an edit menu item, and trigger the menu item in the tool palette menu and/or the application scene to be edited; or the central region is configured to display a menu sub-item of the menu item in the tool palette menu and trigger a function of the menu sub-item to be executed.

In some implementations, the controller 1701 is configured to: display a suspended menu control; display the application menu corresponding to the application scene in response to a triggering operation of the user on the suspended menu control.

In some implementations, the application menu is a tool palette menu, and the tool palette menu includes a central region and at least one annular region surrounding the central region, the controller 1701 is configured to: sequentially display the central region and the at least one annular region of the tool palette menu from inside to outside or from outside to inside in response to a first triggering operation of the user on the suspended menu control; or display the central region of the tool palette menu in response to a second triggering operation of the user on the suspended menu control, and t sequentially display the at least one annular region of the tool palette menu from inside to outside or from outside to inside in response to a third triggering operation of the user on the central region.

In some implementations, the at least one annular region of the tool palette menu includes a plurality of block sub-regions displaying the menu items in one-to-one correspondence, and the block sub-regions of the at least one annular region are sequentially displayed in a clockwise direction or a counterclockwise direction during the at least one annular region being displayed.

Based on the same inventive concept as above, an embodiment of the present disclosure further provides a menu display apparatus, the apparatus is an apparatus for implementing the method in the embodiment of the present disclosure, and the principle of the apparatus to solve the technical problem is similar to that of the method described above. Thus, the implementation of the apparatus may refer to the implementation of the method described above, and the repeated contents are not described here again.

As shown in FIG. 18, the apparatus includes a display unit 1800 configured to display an application menu corresponding to an application scene in response to a menu triggering operation triggered by a user in the application scene, the application menu is configured to display a plurality of menu items, the menu triggering operation is the same for different application scenes, and at least part of the menu items are displayed to be different for different application scenes.

In some implementations, the menu items includes at least one first menu item and at least one second menu item, the first menu item is displayed by the application menu to be the same for different application scenes, and the second menu item is displayed by the application menu to be different for different application scenes.

In some implementations, the at least one first menu item is configured to display a system menu item or an application menu item, the at least one second menu item is configured to display an application menu item or a function menu item, the system menu item is configured to trigger a function built in an operating system to be executed, the application menu item is configured to trigger to enter a corresponding third-party application interface, and the function menu item is configured to trigger the corresponding function in the application scene to be executed.

In some implementations, the first menu item is configured to display the system menu item or the application menu item, and the second menu item is configured to display the function menu item; or the first menu item is configured to display the system menu item, and the second menu item is configured to display the application menu item.

In some implementations, the application scene is the Home application, the first menu item is configured to display the system menu item, and the second menu item is configured to display the application menu item.

In some implementations, the display unit 1800 is configured to: start the third-party application corresponding to the application menu item in response to a user's start triggering operation on the application menu item in the Home application.

In some implementations, the application scene is the non-Home application, the first menu item is configured to display the system menu item or the application menu item, and the second menu item is configured to display the function menu item.

In some implementations, the application menu includes a first menu and a second menu, and the menu triggering operation includes a first triggering operation and a second triggering operation; the display unit 1800 is configured to: display the first menu in response to the first triggering operation triggered by the user in the application scene; display the second menu in response to the second triggering operation triggered by the user in the first menu; the first triggering operation is the same for different application scenes, and the second triggering operation is the same for different application scenes.

In some implementations, the first menu is configured to display the first menu item to be the same for different application scenes, and the second menu is configured to display the second menu item to be different for different application scenes; or the first menu is configured to display the second menu item to be different for different application scenes, and the second menu is configured to display the first menu item to be the same for different application scenes.

In some implementations, the application menu is a sidebar menu, and the first menu and the second menu are arranged left and right or up and down.

In some implementations, the application menu is a tool palette menu, the first menu is a first annular region, and the second menu is a second annular region, and the first annular region is distributed around the second annular region, or the second annular region is distributed around the first annular region.

In some implementations, the application menu is a tool palette menu, the tool palette menu includes a third annular region and a fourth annular region, the third annular region is distributed around the fourth annular region, or the fourth annular region is distributed around the third annular region; the third annular region is configured to display the first menu item to be the same for different application scenes, and the fourth annular region is configured to display the second menu item to be different for different application scenes; or the third annular region is configured to display the second menu item to be different for different application scenes, and the fourth annular region is configured to display the first menu item to be the same for different application scenes.

In some implementations, in response to the application scene being a first application scene, the application menu includes a third menu, in response to the application scene being a second application scene, the application menu includes a fourth menu, at least one menu item displayed by the third menu is different from any menu item displayed by the fourth menu, and the menu triggering operation triggered in the first application scene is the same as the menu triggering operation triggered in the second application scene.

In some implementations, the display unit 1800 is configured to: display a fifth menu in response to a triggering operation on the fourth menu by the user, at least one menu item displayed by the fifth menu is the same as at least one menu item displayed by the third menu.

In some implementations, the tool palette menu further includes a central region located in a center of the first annular region, and the central region is configured to trigger an operation corresponding to the menu item to be executed.

In some implementations, the central region is configured to display an edit menu item, and trigger the menu item in the tool palette menu and/or the application scene to be edited; or the central region is configured to display a menu sub-item of the menu item in the tool palette menu and trigger a function of the menu sub-item to be executed.

In some implementations, the display unit 1800 is configured to: display a suspended menu control; display the application menu corresponding to the application scene in response to a triggering operation of the user on the suspended menu control.

In some implementations, the application menu is a tool palette menu, and the tool palette menu includes a central region and at least one annular region surrounding the central region, the display unit 1800 is configured to: sequentially display the central region and the at least one annular region of the tool palette menu from inside to outside or from outside to inside in response to a first triggering operation of the user on the suspended menu control; or display the central region of the tool palette menu in response to a second triggering operation of the user on the suspended menu control, and sequentially display the at least one annular region of the tool palette menu from inside to outside or from outside to inside in response to a third triggering operation of the user on the central region.

In some implementations, the at least one annular region of the tool palette menu includes a plurality of block sub-regions displaying the menu items in one-to-one correspondence, the block sub-regions of the at least one annular region are sequentially displayed in a clockwise direction or a counterclockwise direction during the at least one annular region being displayed.

An embodiment of the present disclosure provides a menu display method of an electronic interactive display panel, the electronic interactive display panel includes a touch display screen, and as shown in FIG. 19, the menu display method includes a following step 1900.

At step 1900, displaying a writing configuration menu on a touch display screen, with the writing configuration menu including a plurality of first-level menu options in one-to-one correspondence with one or more writing tools; the writing configuration menu has a regular shape including a central region and at least one annular region surrounding the central region, the at least one annular region includes a plurality of block sub-regions displaying the first-level menu options in one-to-one correspondence, and the central region is configured to display lower-level menu options of the first-level menu options.

In some implementations, the tool palette menu further includes an adjustment control for displaying the first-level menu options; the adjustment control is arranged at least in the central region.

In some implementations, an outermost annular region of the at least one annular region is a first annular region, the first-level menu options are displayed in the first annular region, and the adjustment control arranged in the central region includes the lower-level menu options of the first-level menu options; in response to the user calling out the tool palette menu of the application on the touch display screen, the first-level menu options are displayed in the first annular region, a function of a selected one of the first-level menu options is started, and the lower-level menu option of the started first-level menu option is displayed in the central region; or the lower-level menu option of the selected first-level menu option is displayed in the central region in response to a selection operation of the user on the first-level menu option.

In some implementations, at least one tool includes one or more attributes; the lower-level menu option of the first-level menu option corresponding to each tool is configured to display the one or more attributes; in response to the lower-level menu option being configured to display more than one attributes, the method further including: switching the attribute currently displayed to be another attribute to be displayed in response to an operation of the user on the attribute of the lower-level menu option currently displayed.

In some implementations, the tool palette menu is a writing configuration menu, and the first-level menu options include one or more of an option of handwriting tool, an option of stylus tool, an option of eraser tool, an option of file insertion, an option of canvas dragging tool, a cancel function option, or a restore function option, the attribute of the stylus tool includes at least one of a width, a transparency or a color of a track, the attribute of the handwriting tool includes at least one of a width, a transparency or a color of a track, and the attribute of the eraser tool includes at least one of an erasing area of the eraser tool or an erasing shape of the eraser tool.

In some implementations, the application of the electronic interactive display panel further includes a partition operation mode, and the method further includes determining a partition controlled by a suspended button or the writing configuration menu according to a triggered position of the suspended button or the writing configuration menu.

In some implementations, in the partition operation mode, one writing configuration menu and at least two partitions are displayed on the touch display screen, different partitions are configured to be written under the same or different writing parameters, and the writing configuration menu is configured to adjust the writing parameter.

In some implementations, the first-level menu options further include an option of the partition operation mode, lower-level menu options of the partition operation mode include: a two-partition mode, a three-partition mode, a four-partition mode and a manual partition mode, the method further includes switching between different partition modes in response to continuous selection operations of the user on the lower-level menu options of the partition operation mode.

In some implementations, the application of the electronic interactive display panel further includes a multi-person writing mode, at least two writing configuration menus are displayed on the touch display screen in the multi-person writing mode, the method further includes determining the writing configuration menu for controlling the writing parameter of a writing operation according to a distance between a writing point of the writing operation and each of the at least two writing configuration menus.

In some implementations, the first-level menu options further include an option for the multi-person writing mode, a lower-level menu option of the multi-person writing mode includes a total number of the writing configuration menus.

In some implementations, regions controlled by the writing configuration menus are determined according to a horizontal distance between any two writing configuration menus, different writing configuration menus are configured with the same or different writing parameters; each writing configuration menu independently controls the writing parameter of the region corresponding to the writing configuration menu.

In some implementations, the tool palette menu further includes an adjustment control for displaying the first-level menu options, the adjustment control are arranged at least in the central region and the second annular region. Referring to FIG. 20, the first-level menu options may include options of volume, brightness, menu, edit, screen capture, live. For example, in response to a touch operation of the user on the adjustment control of the option of volume, the volume is displayed in the central region, and a progress bar of the volume is displayed in the second annular region.

In some implementations, the adjustment control arranged in the central region includes a lower-level menu option of the first-level menu option, and the adjustment control arranged in the second annular region includes an attribute progress bar or an attribute parameter adjustment icon matched with the displayed lower-level menu option.

In some implementations, in the menu display method provided in the embodiment of the present application, the application of the electronic interactive display panel further includes the partition operation mode or the multi-person writing mode. As shown in FIG. 21, the first-level menu options of the writing configuration menu for the writing application on the touch display screen further include an option M1-7 for the partition operation mode or an option M1-7 for the multi-person writing mode. The partition operation mode is an operation mode in which the user may write in different partitions of the display screen, and the multi-person writing mode is a mode in which multiple users may simultaneously write in different positions of the display screen.

In the partition operation mode, only one writing configuration menu or suspended button is displayed on the touch display screen, the partition operation mode corresponds to at least two partitions, different partitions are configured to perform the writing operation with different writing parameters respectively. Alternatively, different partitions may be configured to perform the writing operation with the same writing parameters.

In some implementations, the lower-level menu options of the partition operation mode include: a manual partition mode, a two-partition mode, a three-partition mode, a four-partition mode, and the like. For example, the two-partition mode includes a left-right partition mode or an up-down partition mode; the three-partition mode includes a partition mode with one row and three columns or a partition mode with 1 column and 3 rows; the four-partition mode includes a partition mode with 2 rows and 2 columns, a partition mode with 1 rows and 4 columns, or a partition mode with 1 column and 4 rows. Alternatively, other partition modes are also possible, which are not limited herein. The manual partition mode means that the user can manually divide the region on the display screen. A shape and a size of each divided region are not limited herein.

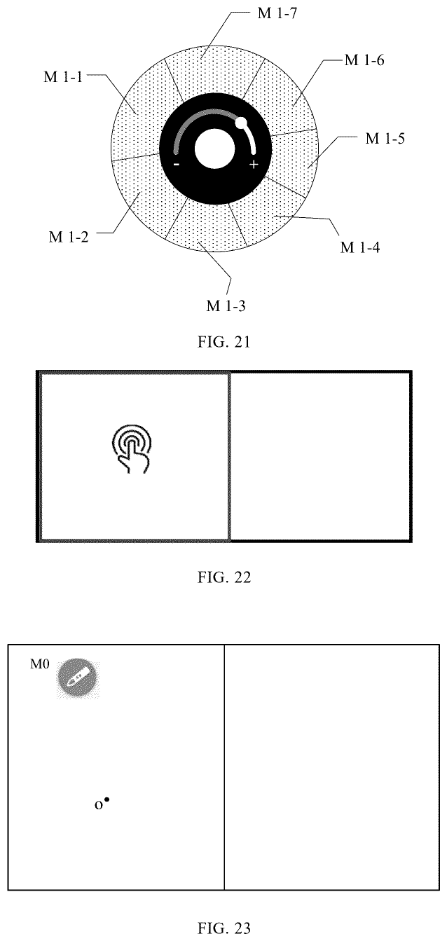

In some implementations, the partition controlled by the writing configuration menu is determined according to a position at which the suspended button or the writing configuration menu is triggered. By taking the left-right partition mode as an example, if the suspended button is clicked on the left side of the display screen, the writing configuration menu is displayed on the left side of the display screen and controls the writing parameters on the left side of the display screen. If the user clicks the option M1-7 of the partition operation mode of the writing configuration menu, a schematic diagram illustrating a positional relationship between the region where the user is writing and the full display screen is displayed in the central region M2, as shown in FIG. 22. As can be seen in FIG. 22, the user is writing in the left region of the display screen. The writing parameters configured by the user during writing on the left side are stored separately from the writing parameters configured during writing on the right side.

FIG. 23 is a schematic diagram illustrating a position of a suspended button during being triggered and a partition controlled by the suspended button. By taking the left-right partition mode as an example, if the suspended button MO is triggered in the left region of the display screen, the suspended button MO controls the writing parameters of the left region, i.e., the region where the position O is located.

For example, the partition operation mode may be triggered in the following three ways. In the first way, the partition operation mode is enabled in response to a long-press operation on the suspended button by the user. For example, in response to the long-press operation on the suspended button by the user, a selection box is generated, and includes the manual partition mode, the two-partition mode, the three-partition mode, the four-partition mode, and the like. If the four-partition mode is selected by the user, the four-partition operation mode is enabled. In the second way, in response to a preset triggering instruction of the user on the touch display screen, e.g., five fingers simultaneously clicking the touch display screen, the partition operation mode is enabled, and the writing configuration menu is displayed simultaneously. In the third way, the partition operation mode is triggered by clicking the option M1-7 of the partition operation mode.

In some implementations, the switching between different partition modes may be performed in response to continuous selection operations of the user on the lower-level menu options of the partition operation mode.

In some implementations, in the multi-person writing mode, at least two writing configuration menus are displayed on the touch display screen, and the lower-level menu option of the multi-person writing mode includes: the number of the writing configuration menus.

For example, the multi-person writing mode may be triggered in the following three ways. In the first way, the multi-person writing mode is enabled in response to a long-press operation on the suspended button by the user. For example, in response to the long-press operation on the suspended button by the user, a selection box is generated, so that the user can select a mode in which two persons can simultaneously write (a 2-person writing mode), a mode in which three persons can simultaneously write (a 3-person writing mode), or a mode in which four persons can simultaneously write (a 4-person writing mode), or the like. In the second way, in response to a preset triggering instruction of the user on the touch display screen, e.g., five fingers simultaneously clicking the touch display screen, the multi-person writing mode is enabled, and the writing configuration menu is simultaneously displayed. In the third way, the multi-person writing mode is triggered by clicking the option M1-7 of the multi-person writing mode.

In some implementations, if the 2-person writing mode is enabled, two writing configuration menus or two suspended buttons are displayed on the display screen; if the 3-person writing mode is enabled, three writing configuration menus or three suspended buttons are displayed on the display screen; and if the 4-person writing mode is enabled, four writing configuration menus or four suspended buttons are displayed on the display screen. For example, the writing configuration menus or the suspended buttons are displayed sequentially from left to right on the display screen. Each user may choose to display the writing configuration menus, or hide the writing configuration menus, i.e., display the suspended buttons.

In some implementations, the writing configuration menu or suspended button controlling the writing parameters of the writing operation is determined according to a distance between the writing point of the writing operation and each of the writing configuration menus or suspended buttons. For example, in response to a writing operation of the user at an arbitrary position, the writing configuration menu or suspended button closest to the position controls the writing parameters at the position, that is, the writing configuration menu or the suspended button close to the writing point triggered by the user during writing may control the writing parameters at the position of the writing point.

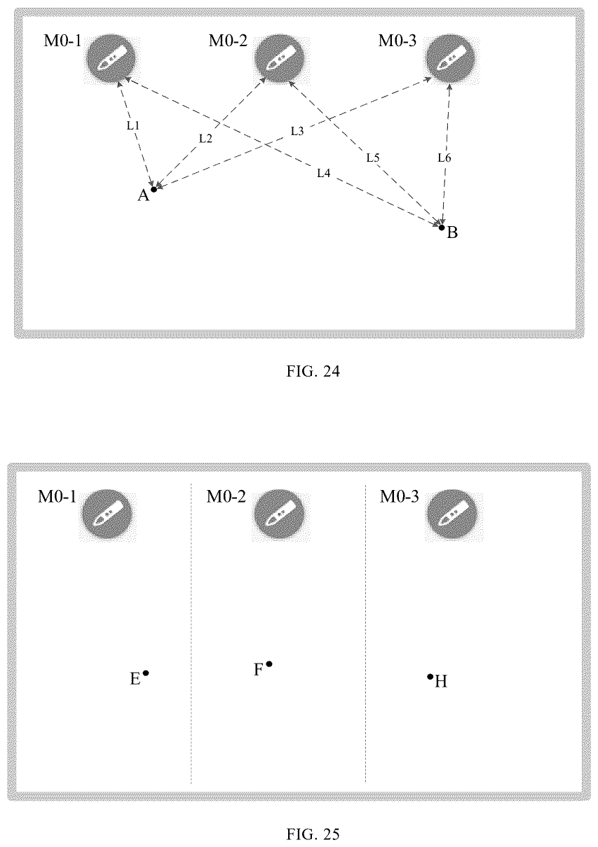

For example, FIG. 24 is a schematic diagram illustrating a distance relationship between positions at which different users perform writing operations on a touch display screen and suspended buttons. As shown in FIG. 24, three suspended buttons are displayed on the touch display screen, and if a stylus tool is detected at position A, that is, if a first user performs a writing operation at position A, a suspended button M0-1 closest to position A controls a width, a transparency, and a color of the corresponding track written at position A. If the stylus tool is detected at position B, that is, if a second user performs a writing operation at position B, a suspended button M0-3 closest to position B controls a width, a transparency, and a color of the corresponding track written at position B. A position of a third user performing a writing operation on the touch display screen is not shown in FIG. 24. Different writing configuration menus may be configured with the same or different writing parameters, and each writing configuration menu independently controls the writing parameters of the region corresponding to the writing configuration menu.

In some implementations, writing regions controlled by the writing configuration menus or the suspended buttons may be determined based on a horizontal distance between any two writing configuration menus, i.e., only the horizontal distance is considered. For example, a perpendicular bisector of a line connecting any two writing configuration menus or suspended buttons serves as a dividing line between the writing regions controlled by the two writing configuration menus or suspended buttons.

FIG. 25 is a schematic diagram of positions at which different users perform writing operations on a touch display screen and corresponding suspended buttons. As shown in FIG. 25, three suspended buttons are displayed on the touch display screen, and there is a perpendicular bisector between any two suspended buttons, e.g., a dashed line as shown in FIG. 25. If the eraser is detected at position E, that is, if a first user performs a writing operation at position E, a suspended button M0-1 controls an erasing area, an erasing shape of the corresponding eraser, and the like at position E. If the stylus tool is detected at the position F, that is, if a second user performs a writing operation at position F, a suspended button M0-2 controls a width, a transparency and a color of the corresponding track written at position F. If the stylus tool is detected at position H, that is, if a third user performs a writing operation at position H, a suspended button MO-3 controls a width, a transparency and a color of the corresponding track written at position H.

In some implementations, if the partition operation mode is enabled, the writing parameters configured before the partition operation mode being enabled are saved, and after the partition operation mode is disenabled, the writing parameters configured before the partition operation mode being enabled are automatically restored. In some implementations, if the multi-person writing mode is enabled, the writing parameters configured in the single-person writing mode are saved, and if the multi-person writing mode is disenabled, the writing parameters configured in the single-person writing mode are automatically restored.

Based on the same inventive concept as above, an embodiment of the present disclosure further provides a computer storage medium having a computer program stored thereon, the program, executed by a processor, causes the processor to: display an application menu corresponding to an application scene in response to a menu triggering operation triggered by a user in the application scene, the application menu being configured to display a plurality of menu items, the menu triggering operation is the same for different application scenes, and at least part of the menu items are displayed to be different for different application scenes.

As will be appreciated by one of skilled in the art, the embodiments of the present disclosure may provide a method, system, or computer program product. Accordingly, the present disclosure may take the form of an entirely hardware embodiment, an entirely software embodiment or an embodiment combining software and hardware aspects. Furthermore, the present disclosure may take the form of a computer program product embodied on one or more computer-usable storage medium (including, but not limited to, disk storage, optical storage, and the like) having computer-usable program code embodied therein.

The present disclosure is described with reference to flowchart and/or block diagrams of methods, apparatus (systems), and computer program products according to the embodiments of the present disclosure. It will be understood that each flow and/or each block of the flowchart and/or block diagrams, and combinations of flows and/or blocks in the flowchart and/or block diagrams, may be implemented by computer program instructions. These computer program instructions may be provided to a processor of a general purpose computer, special purpose computer, embedded processor, or other programmable data processing apparatus to produce a machine, such that the instructions, which are executed via the processor of the computer or other programmable data processing apparatus, create means for implementing the functions specified in one or more flows in the flowchart and/or one or more blocks in the block diagram.

These computer program instructions may also be stored in a computer-readable memory that can direct a computer or other programmable data processing apparatus to function in a particular manner, such that the instructions stored in the computer-readable memory produce products including instruction means which implement the functions specified in the one or more flows in the flowchart and/or one or more blocks in the block diagram.

These computer program instructions may also be loaded onto a computer or any other programmable data processing apparatus to cause a series of operational steps to be performed on the computer or the programmable data processing apparatus, so as to produce a computer implemented process, such that the instructions which are executed on the computer or other programmable data processing apparatus provide steps for implementing the functions specified in one or more flows in the flowchart and/or one or more blocks in the block diagram.

It will be apparent to one of skilled in the art that variations and modifications may be made to the present disclosure without departing from the spirit and scope of the present disclosure, and if such modifications and variations fall within the scope of the appended claims and their equivalents, it is intended that the present disclosure also encompass such modifications and variations.

1. A menu display method, comprising:
displaying an application menu corresponding to an application scene in response to a menu triggering operation triggered by a user in the application scene,
wherein the application menu is configured to display a plurality of menu items, the menu triggering operation is the same for different application scenes, and at least part of the menu items are displayed to be different for different application scenes.

2. The method of claim 1, wherein the menu items comprises at least one first menu item and at least one second menu item, and
the first menu item is displayed by the application menu to be the same for different application scenes, and the second menu item is displayed by the application menu to be different for different application scenes.

3. The method of claim 2, wherein the at least one first menu item is configured to display a system menu item or an application menu item, the at least one second menu item is configured to display an application menu item or a function menu item; and
wherein the system menu item is configured to trigger a function built in an operating system to be executed, the application menu item is configured to trigger to enter a corresponding third-party application interface, and the function menu item is configured to trigger a corresponding function in the application scene to be executed.

4. The method of claim 3, wherein the at least one first menu item is configured to display the system menu item or the application menu item, and the at least one second menu item is configured to display the function menu item; or
the at least one first menu item is configured to display the system menu item and the at least one second menu item is configured to display the application menu item.

5. The method of claim 4, wherein the application scene is a Home application, the at least one first menu item is configured to display the system menu item, and the at least one second menu item is configured to display the application menu item.

6. The method of claim 5, wherein a third-party application corresponding to the application menu item is started in response to a user's start triggering operation on the application menu item in the Home application.

7. The method of claim 4, wherein the application scene is a non-Home application, the at least one first menu item is configured to display the system menu item or the application menu item, and the at least one second menu item is configured to display the function menu item.

8. The method of claim 2, wherein the application menu comprises a first menu and a second menu, and the menu triggering operation comprises a first triggering operation and a second triggering operation;
the first menu is displayed in response to the first triggering operation triggered by the user in the application scene;
the second menu is displayed in response to the second triggering operation triggered by the user in the first menu; and
wherein the first triggering operation is the same for different application scenes, and the second triggering operation is different for different application scenes.

9. The method of claim 8, wherein the first menu is configured to display the first menu item to be the same for different application scenes, and the second menu is configured to display the second menu item to be different for different application scenes; or
the first menu is configured to display the second menu item to be different for different application scenes, and the second menu is configured to display the first menu item to be the same for different application scenes.

10. The method of claim 8, wherein the application menu is a sidebar menu, and the first menu and the second menu are arranged left and right or up and down.

11. The method of claim 8, wherein the application menu is a tool palette menu; and
the first menu is a first annular region, the second menu is a second annular region, and the first annular region is distributed around the second annular region, or the second annular region is distributed around the first annular region.

12. The method of claim 2, wherein the application menu is a tool palette menu, the tool palette menu comprises a third annular region and a fourth annular region, and the third annular region is distributed around the fourth annular region, or the fourth annular region is distributed around the third annular region; and
the third annular region is configured to display the first menu item to be the same for different application scenes, and the fourth annular region is configured to display the second menu item to be different for different application scenes; or
the third annular region is configured to display the second menu item to be different for different application scenes, and the fourth annular region is configured to display the first menu item to be the same for different application scenes.

13. The method of claim 1, wherein the displaying an application menu corresponding to an application scene in response to a menu triggering operation triggered by a user in the application scene comprises:
in response to the application scene being a first application scene, the application menu comprises a third menu;
in response to the application scene being a second application scene, the application menu comprises a fourth menu; and
wherein at least one menu item displayed by the third menu is different from any menu item displayed by the fourth menu, and the menu triggering operation triggered in the first application scene is the same as the menu triggering operation triggered in the second application scene.

14. The method of claim 13, wherein a fifth menu is displayed in response to a triggering operation on the fourth menu by the user, and at least one menu item displayed by the fifth menu is the same as at least one menu item displayed by the third menu.

15. The method of claim 11, wherein the tool palette menu further comprises a central region in a center of the first annular region, and the central region is configured to trigger an operation corresponding to the menu item to be executed.

16. The method of claim 15, wherein the central region is configured to display an edit menu item, and trigger the menu item in the tool palette menu and/or the application scene to be executed; or
the central region is configured to display a menu sub-item of the menu item in the tool palette menu and trigger a function of the menu sub-item to be executed.

17. The method of claim 1, wherein the displaying an application menu corresponding to an application scene in response to a menu triggering operation triggered by a user in the application scene comprises:
displaying a suspended menu control; and
displaying the application menu corresponding to the application scene in response to a triggering operation of the user on the suspended menu control.

18. The method of claim 17, wherein the application menu is a tool palette menu, and the tool palette menu comprises a central region and at least one annular region surrounding the central region; and
the displaying the application menu corresponding to the application scene in response to a triggering operation of the user on the suspended menu control comprises:
sequentially displaying the central region and the at least one annular region of the tool palette menu from inside to outside or from outside to inside in response to a first triggering operation of the user on the suspended menu control; or
displaying the central region of the tool palette menu in response to a second triggering operation of the user on the suspended menu control, and sequentially displaying the at least one annular region of the tool palette menu from inside to outside or from outside to inside in response to a third triggering operation of the user on the central region.

19. The method of claim 11, wherein the at least one annular region of the tool palette menu comprises a plurality of block sub-regions displaying the menu items in one-to-one correspondence; and
the block sub-regions of the at least one annular region are sequentially displayed in a clockwise direction or a counterclockwise direction during the at least one annular region being displayed.

20. (canceled)

21. A computer storage medium having a computer program stored thereon, wherein the computer program, executed by a processor, causes the processor to implement the method of any one of claim 1.
